(19) United States
(12) Patent Application Publication
(10) Pub. No.: US 2004/0109608 A1
(43) Pub. Date: Jun. 10, 2004

(54) Systems and methods for analyzing two-dimensional images

(76) Inventors: Patrick B. Love, Bellingham, WA (US); William Paul Rogers, Bellingham, WA (US); Steven R. Brinn, Bellingham, WA (US)

Correspondence Address: PERKINS COIE LLP, PATENT-SEA, P.O. BOX 1247, SEATTLE, WA, 98111-1247, US

(21) Appl. No.: 10/646,531

(22) Filed: Aug. 23, 2003

Related U.S. Application Data
(63) Continuation-in-part of application No. 10/194,707, filed on Jul. 12, 2002.

(51) Int. Cl. G06K 9/62; G06K 9/00

(52) U.S. Cl. 382/224; 382/154

(57) ABSTRACT

Methods and systems for creating and searching a library of classifications of image features. These methods and systems include receiving a digital image of a physical object, generating a multi-dimensional surface model from the received digital image of the physical object which differs from the received digital image, providing an output that displays the generated multi-dimensional surface model, analyzing the generated multi-dimensional surface model to determine selected features of the received digital image, classifying the determined features, storing the feature classifications, creating an algorithm for locating classified features in surface models of physical objects based on the stored classifications, and storing the algorithm. Images, surface models, and features may be stored in a database in accordance with the stored classifications. Images may be analyzed and the database may be searched for entries matching features of the analyzed images.

### CROSS-REFERENCE TO RELATED APPLICATION(S)

This application is a Continuation-In-Part of U.S. application Ser. No. 10/194,707, which was filed on Jul. 12, 2002, and which is incorporated herein by reference.

### TECHNICAL FIELD

The present invention relates generally to systems and methods for the analysis of two-dimensional images and, more particularly to systems and methods for analyzing two-dimensional images by using image values such as color or grey scale density of the image to create a multi-dimensional model of the image for further analysis.

### BACKGROUND

There are numerous circumstances in which it is desirable to analyze a two-dimensional image in detail. For example, it is frequently necessary to analyze and compare handwriting samples to determine the authenticity of a signature or the like. Similarly, fingerprints, DNA patterns (“smears”) and ballistics patterns also require careful analysis and comparison in order to match them to an individual, a weapon, and so on. Outside the field of criminology, many industrial and manufacturing processes and tests involve analysis of two-dimensional images, one example being the analysis of the contact patterns generated by pressure between the mating surfaces of an assembly. In the medical field, images are frequently used for diagnostic purposes and/or during surgical procedures.

Accordingly, a vast array of two-dimensional images requires analysis and comparison. For the purpose of illustrating a preferred embodiment of the present invention, the following discussion will focus mainly on the analysis of forensic and medical images. However, it will be understood that the scope of the present invention includes analysis of all two-dimensional images that are susceptible to the methods described herein.

Conventional techniques for analyzing two-dimensional images are generally labor-intensive, subjective, and highly dependent on the person's experience and attention to detail. Not only do these factors increase the expense of the process, but they tend to introduce inaccuracies that reduce the value of the results.

The analysis of medical images is one area that particularly illustrates these problems. Two-dimensional medical images are created by various methods such as photographic, x-ray, ultrasound, magnetic resonance imaging, and other techniques. Medical images are often used to diagnose the presence or absence of a medical condition. In addition, medical images are often used as an aid to surgical procedures.

Whether used as a diagnostic or surgical tool, medical images are often difficult to interpret for a variety of reasons. The analysis of medical images thus typically requires a person possessing a high level of skill resulting from a combination of aptitude, training, skill, judgment, and experience. Persons with the requisite skill level may be few in number, which can increase the costs and delay the process of interpreting medical images. In addition, factors such as fatigue and/or interruptions can cause even a person with the requisite skill level to misinterpret or simply miss the features of a medical image indicative of a medical anomaly.

Given the foregoing, the need thus exists for improved systems and methods for interpreting and/or automating the analysis of two-dimensional images such as medical images.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIGS. 1A, 1B, and 1C are block diagrams showing a system for and method of creating and analyzing a surface model based on a source image in accordance with the present invention;

FIG. 2 is a graphical plot in which the vertical axis shows color density/gray scale values that increase and decrease with increasing and decreasing darkness of the two-dimensional image, as measured in a line drawn across the axis of the image;

FIG. 3 is a 3D analysis image of a two-dimensional source image formed in accordance with the present invention, in this case a sample of handwriting, with areas of higher apparent elevation in the analysis image corresponding to areas of increased gray scale density in the two-dimensional image;

FIG. 4 is also a 3D analysis image of a two-dimensional source image formed in accordance with the present invention, with the two-dimensional image again being a sample of handwriting, but in this case with the value of the gray scale density being inverted so as to be represented by the depth of a “channel” or “valley” rather than by the height of a raised “mountain range” as in FIG. 3;

FIG. 5 is a view of a cross-section taken through the virtual 3-D image in FIG. 4, showing the contour of the “valley” which represents increasing and decreasing gray scale darkness/density and which is measured across a stroke of the writing sample, and showing the manner in which the two sides of the image are weighted relative to one another to ascertain the angle in which the writing instrument engaged the paper as the stroke was formed;

FIG. 6 is a reproduction of a sample of handwriting, marked with lines to show the major elements of the writing and the upstroke slants thereof, as these are employed in accordance with another aspect of the present invention;

FIG. 7 is an angle scale having areas which designate a writer's emotional responsiveness based on the angle of the upstrokes, with the dotted line therein showing the average of the slant angles in the handwriting sample of FIG. 6;

FIG. 8 is a reproduction of a handwriting sample as displayed on a computer monitor in accordance with another aspect of the present invention, showing exemplary cursor markings on which measurements are based, and also showing a summary of the relative slant frequencies which are categorized by sections of the slant gauge of FIG. 7;

FIG. 9 is a portion of a comprehensive trait inventory produced for the writing specimen for FIG. 8 in accordance with the present invention;

FIG. 10 is a trait profile comparison produced in accordance with the present invention by summarizing trait inventories in FIG. 9;

FIGS. 11A, 11B, and 11C are block diagrams depicting a system for analyzing handwriting using image processing techniques of the present invention;

FIG. 12 is a screen shot depicting source images formed from mammography X-rays and analysis images of these source images created using the systems and methods of the present invention;

FIG. 13 is a screen shot depicting a source image formed from pap smear images and an analysis image of this source image created using the systems and methods of the present invention;

FIG. 14 is a screen shot depicting a source image formed from retinal blood vessel and structure image and an analysis image of this source image created using the systems and methods of the present invention;

FIG. 15 is a screen shot depicting a source image formed from a sonogram and an analysis image of this source image created using the systems and methods of the present invention;

FIGS. 16 and 17 are screen shots depicting source images formed from dental X-rays and analysis images of these source images created using the systems and methods of the present invention;

FIG. 18 is a screen shot depicting a source image formed from an X-ray of a human joint and an analysis image of this source image created using the systems and methods of the present invention;

FIG. 19 is a screen shot depicting a source image formed from a scan of a handwriting sample showing two intersecting lines and an analysis image of this source image created using the systems and methods of the present invention;

FIGS. 20, 21, and 22 are screen shots depicting analysis images created using the systems and methods of the present invention, where these analysis images highlight the differences in copy generations of the related document images;

FIG. 23 is a screen shot depicting a source image formed from a scan of pen samples showing and an analysis image of this source image created using the systems and methods of the present invention;

FIG. 24 is a screen shot depicting a source image formed from a scan of a handwriting sample showing line striations of a ballpoint pen and an analysis image of this source image created using the systems and methods of the present invention;

FIG. 25 is a screen shot depicting a source image formed from a scan of a watermarked sheet of paper and an analysis image of this source image created using the systems and methods of the present invention;

FIG. 26 is a screen shot depicting a source image formed from a scan of a paper sample and an analysis image of this source image created using the systems and methods of the present invention;

FIG. 27 is a screen shot depicting a source image formed from blood splatter image and an analysis image of this source image created using the systems and methods of the present invention; and

FIG. 28 is a screen shot depicting a source image formed from a fingerprint image and an analysis image of this source image created using the systems and methods of the present invention.

FIG. 29 is a flow diagram illustrating an overview of the system used to create a database of image classifications and features in an embodiment.

FIG. 30 is a flow diagram illustrating a method for creating a database of feature classifications in an embodiment.

FIG. 31 is a flow diagram illustrating a method for identifying and storing features of an image in an embodiment.

FIG. 32 is a flow diagram illustrating a method for comparing features in a provided image with a database of stored image features in an embodiment.

FIG. 33 is an illustration of a fingerprint image provided to the system.

FIG. 34 illustrates a result of processing of the fingerprint of FIG. 33 in one embodiment.

FIG. 35 illustrates portions of the surface model of the provided fingerprint illustrated in FIG. 34 that may uniquely identify an individual whose fingerprint appears in FIG. 33.

FIG. 36 illustrates an image of a weld.

FIG. 37 illustrates a surface model created from the image in FIG. 36.

FIGS. 38, 39, and 40 illustrate mammograms over time.

### DETAILED DESCRIPTION

I. Overview

The present invention provides systems and methods for the analysis of two-dimensional images. For purposes of illustration, the present invention will often be described herein in the context of handwriting analysis. However, the invention will also be described below in the context of the analysis of medical and forensic images. It should be understood that present invention may have application to the analysis of these and other types of two-dimensional images; the reference to medical-, handwriting-, or forensic-related source images thus does not limit the scope of the present invention to other types of source images.

In the context of the present application, the term “image” refers to the emission, transmission, or reflection of energy from a thing that may be perceived in some form. In the context of visible light or sound, propagating energy may be perceived by the human senses. In other cases, this energy may not be detectable by human senses and must be detected or measured by other means such as X-ray or MRI image capturing systems.

Commonly, the thing associated with the image is subjected to a source of external energy such as light waves. This type of energy can create an image by passing through the thing or by being reflected off of the thing. In other cases, the thing itself may emit energy in a detectable form; emitted energy may be created wholly from within the thing but can in some situations be excited by external stimuli.

Whether energy is transmitted, reflected, or emitted, images are detected by sensing this energy in some manner and then storing the image as set of data referred to herein as an image data set. The image data set is represented as a plurality of image values each associated with a particular location on a two-dimensional coordinate system. The image may be reproduced by plotting the image values in the two-dimensional coordinate system. Such image reproduction techniques are commonly used by, for example, computer monitors and computer printers.

With many images, the image values of the points are color and/or gray scale values associated with optical intensity. With images derived from other sources, the image values may correspond to other phenomena such as the intensity of X-rays or the like. Even an image formed by a black ink pen on white paper will typically contain variations in gray scale that will form different optical intensities and thus comprise varying image values. A two-dimensional image to be processed according to the principles of the present invention will be referred to herein as the “source image”.

In this application, the terms “two-dimensional” and “three-dimensional”, and “multi-dimensional” are used to refer to mathematical conventions for storing a set of data. While a two-dimensional image may use perspective and other artistic techniques to give the impression of three dimensions, an image having the appearance of three dimensions will be referred to herein as a “3D image” or as an image having a “3D effect”.

The Applicant has recognized that certain features in a typical source image may be either invisible or difficult to detect with the unaided human eye. In particular, a grayscale or color image typically contains 256 shades or gradations, but the human visual system is capable of discerning only approximately 30 individual shades. The unaided human eye is ill-equipped to perceive image details manifested through subtle variations in image intensity values.

In addition, the human visual system processes information received through the eye in a manner that can distort or change the actual underlying image intensity values. In particular, low-level visual processing adapted for edge detection in quickly discerning field of view shapes and sizes actually alters intensity values on either side of sharp steps in image intensity. Furthermore, mid and high-level visual system processing depends on the structure of edge junction points to infer intensity shadings, which can lead to the eye to perceive identical intensity values in various parts of an image as being significantly different.

Accordingly, while subtle changes in shades of an image may contain relevant information, this information is not accurately detected by the unaided human eye. The systems and methods of the present invention significantly enhance the viewer's ability to discern features manifested by exact or subtle variations in image intensity values.

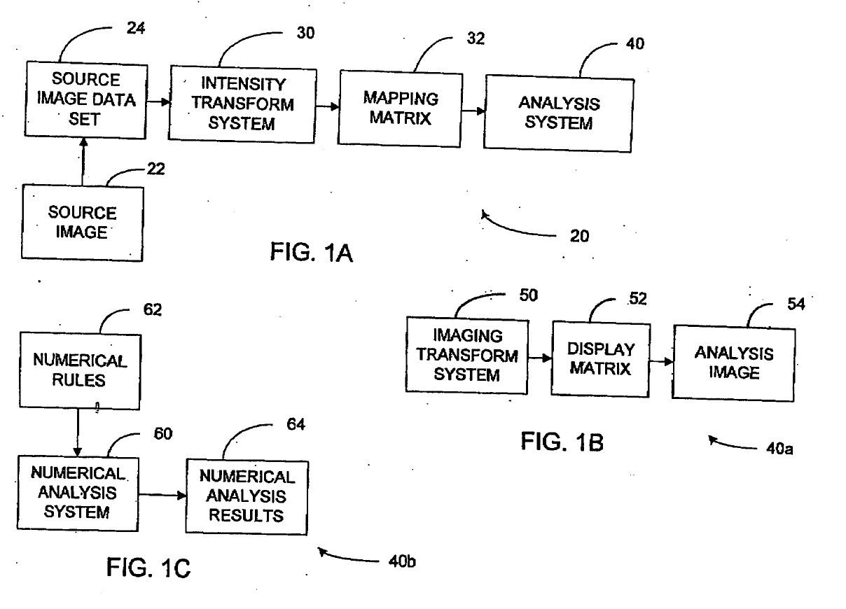

Referring initially to FIG. 1A, depicted at 20 therein is a system for processing two-dimensional images. The processing system 20 comprises a source image 22 having an associated source image data set 24. An intensity conversion system 30 generates a mapping matrix 32 based on the source image data set 24. The mapping matrix 32 represents a three-dimensional surface model as will be described in further detail below. Using this system 20, the mapping matrix 32, or the three-dimensional surface model represented thereby, is analyzed using an analysis module 40 as will be described in further detail below.

More specifically, the source image data set 24 defines an array of image values associated with points in a two-dimensional reference coordinate system. The source image data set 24 will typically include header information and often will be compressed. Typically, the intensity conversion system 30 will remove any header information and uncompress the source image data set of this data set is in a compressed form.

The image values represented by the source image data set 24 may take many forms. In certain imaging systems, the image values will be include values representative of the colors red, blue, and green and a value alpha indicative of transparency (hereinafter “RGBA System”). In other imaging systems, the image values may include values that represent hue (color), saturation (amount of color), and intensity (brightness) (hereinafter “HSI System”).

The mapping matrix 32 is thus a two-dimensional matrix that maps from x-y values of the reference coordinate system to intensity values derived from the image values. The mapping matrix 32 mathematically defines a three-dimensional surface that models or represents the image as defined by the source image data set 24. The term “surface model” will be used herein to refer to the three-dimensional surface defined by the mapping matrix.

The transformation from image values to intensity values may be accomplished in many different ways. As one example, the image values of an RGBA System may be converted to an intensity value by averaging the red, blue, and green values. In another example, the image values of an HSI System may be converted to intensity values by dropping the hue and saturation values and using only the intensity value. In yet another example, the three eight-bit color components in an RGBA System may be summed, and the result may be used as an intensity value. In another example, each eight-bit color component of an RGBA System may be used as an intensity value in a unique imaginary dimensional axis, and these additional imaginary dimensional axes may be stored in an appropriate multi-dimensional matrix. In any case, the transformation process may also involve scaling or other processing of the image values.

The surface model may be analyzed in a number of ways. Referring initially to FIG. 1B, depicted at 40a therein is a first example of an analysis module that may be used as part of the processing system 20. The analysis module 40a comprises an image conversion system 50 that converts the mapping matrix 32 into a display matrix 52. The display matrix 52 is a three-dimensional matrix that maps from x-y-z values to display values. The display matrix 52 allows the three-dimensional surface defined by the surface model to be reproduced as a two-dimensional analysis image 54.

In particular, the display values of the display matrix 52 are or may be similar to the intensity values described above. The display values contain information that allows each point on the three-dimensional surface to be reproduced using conventional display systems and methods. In addition, the use of a three-dimensional display matrix 52 to store the display values allows the reproduction of the three-dimensional surface to be altered to enhance the ability to see details of the three-dimensional surface. For example, the three-dimensional matrix allows the reproduction of the three-dimensional surface to be rotated, translated, scaled, and the like as will be described in further detail below.

The display values may be arbitrarily assigned for different points on the three-dimensional surface to further enhance the reproduction of the three-dimensional surface. For example, each intensity value may be assigned a unique color from an arbitrary spectrum of colors to illustrate patterns of intensity values.

The analysis image 54 may thus be reproduced using artistic techniques that create a 3D effect that represents the x-, y-, and z-axes of three-dimensional surface defined by the mapping matrix. In many situations, viewing a reproduction of the analysis image 54 facilitates the precise measurement and evaluation of various aspects of the source image 22 associated with features of interest.

In a second example, the multi-dimensional model may be analyzed by performing a purely mathematical analysis of the data set representing the multi-dimensional model. Referring for a moment to FIG. 1C, depicted therein is yet another exemplary analysis module 40b comprising a numerical analysis system 60, a set of numerical rules 62, and numerical analysis results 64.

The numerical analysis system 60 is typically formed by a computer capable of comparing the surface model as represented by the mapping matrix 32 with the set of numerical rules 62 associated with features of interest in the source image 22. The numerical rules 62 typically correspond to patterns, minimum or maximum thresholds, and/or relationships between intensity values that indicate or are associated with the features of interest. If the data stored by the mapping matrix 32 matches one or more of the rules, the numerical analysis results 64 will indicate the likelihood that the source image 22 contains the feature of interest.

In a third example, the present invention may be implemented by using both the analysis module 40a and the analysis module 40b described above. In this case, the analysis module 40b containing the numerical analysis system 60 may be used first to screen a batch of source images 22, and the analysis module 40a may be used to analyze those source images 22 of the batch contained in the numerical analysis results.

II. Analysis Techniques

Referring again for a moment to the source image 22, the terms “color density” or “gray scale density” generally correspond to the darkness of the source image at any particular point. In the example of a handwriting stroke formed on white paper, the source image will be lighter (i.e., have a lower color/gray scale density) along its edge, will grow darker (i.e., have a greater color/gray scale density) towards its middle, and will then taper off and become lighter towards its opposite edge. In other words, measured in a direction across the line, the color/gray scale density is initially low, then increases, and then decreases again.

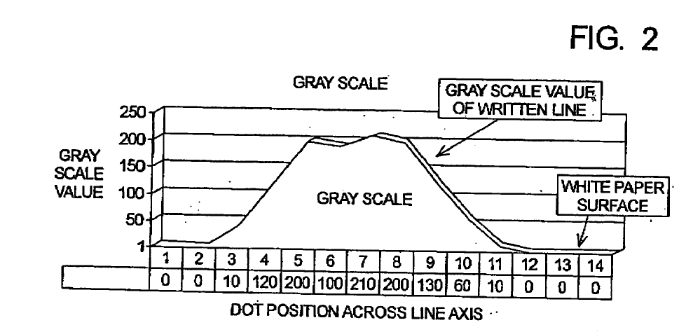

FIG. 2 shows a two-dimensional plot of intensity value (gray scale) of a portion of a handwriting sample at fourteen separate dot locations. For simplicity and clarity, the fourteen image values are plotted on a linear reference coordinate system in FIG. 2. The increasing and decreasing color/gray scale density values are plotted on a vertical axis relative to dot locations across the two-dimensional source image, i.e., along one of the x- and y-axes. The color/gray scale density can thus be used to calculate a third axis (a “z-axis”) in the vertical direction, which when combined with the x- and y-axes of the two-dimensional source image, forms the mapping matrix 32 that defines the three-dimensional surface model.

The surface model so generated can be numerically analyzed and/or converted into an analysis image that can be printed, displayed on a computer monitor or other viewing device, or otherwise reproduced in a visually perceptible form. Although the analysis image itself is represented in two dimensions (e.g., on a sheet of paper or a computer display), as described above the analysis image will often contain artistic “perspective” that will makes the analysis image appear to be a 3D image having three dimensions.

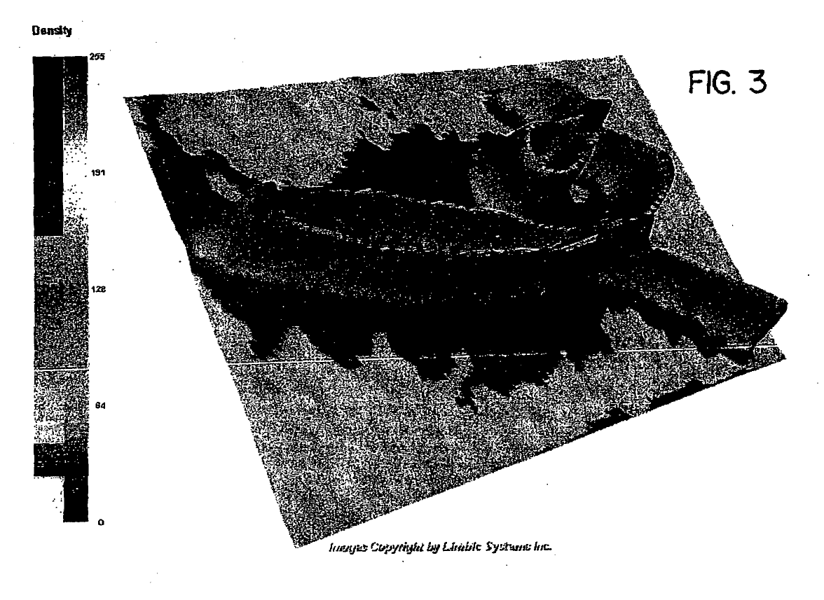

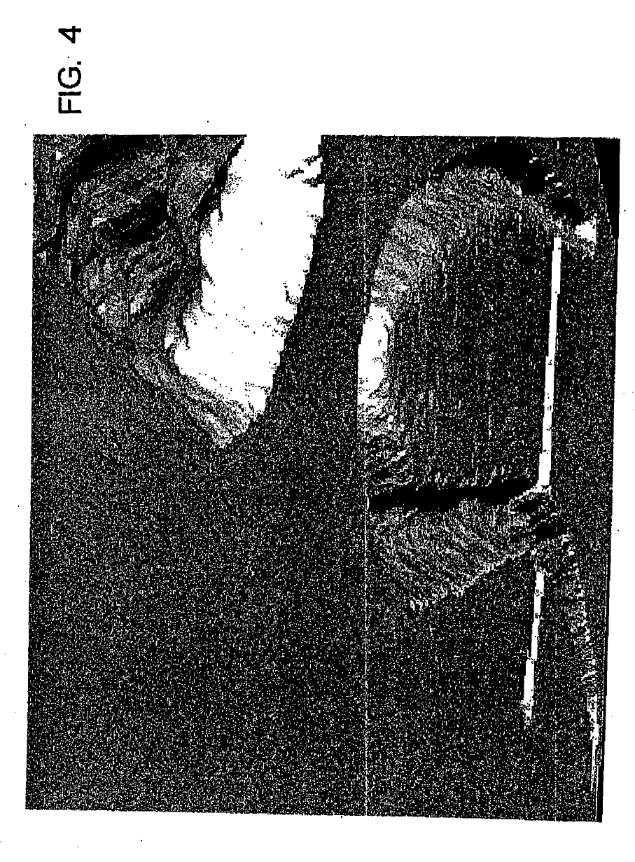

For example, as is shown in FIG. 3, optical density measurements can be given positive values so that the z-axis extends upwardly from the plane defined by the x- and y-axes. When this data is plotted in two-dimensions, the 3D analysis image so produced depicts the three-dimensional surface in the form of a raised “mountain range”; alternatively, the z-axis may be in the negative direction, so that the three-dimensional surface depicted in the analysis image appears as a channel or “canyon” as shown in FIG. 4.

Furthermore, as indicated by the scale on the left side of FIG. 3, the analysis image may include different shades of gray or different colors to aid the operator in visualizing and analyzing the “highs” and “lows” of the image. The use of color to represent the analysis image is somewhat analogous to the manner in which elevations are indicated by designated colors on a map. In addition, a “shadow’ function may be included to further heighten the 3D effect.

The analysis image representing the surface model makes it possible for the operator to see and evaluate features of the source image that were not visible or which do not stand out to the unaided eye. The analysis of several aspects of the surface model and the analysis image associated therewith will be now described in the context of a handwriting sample.

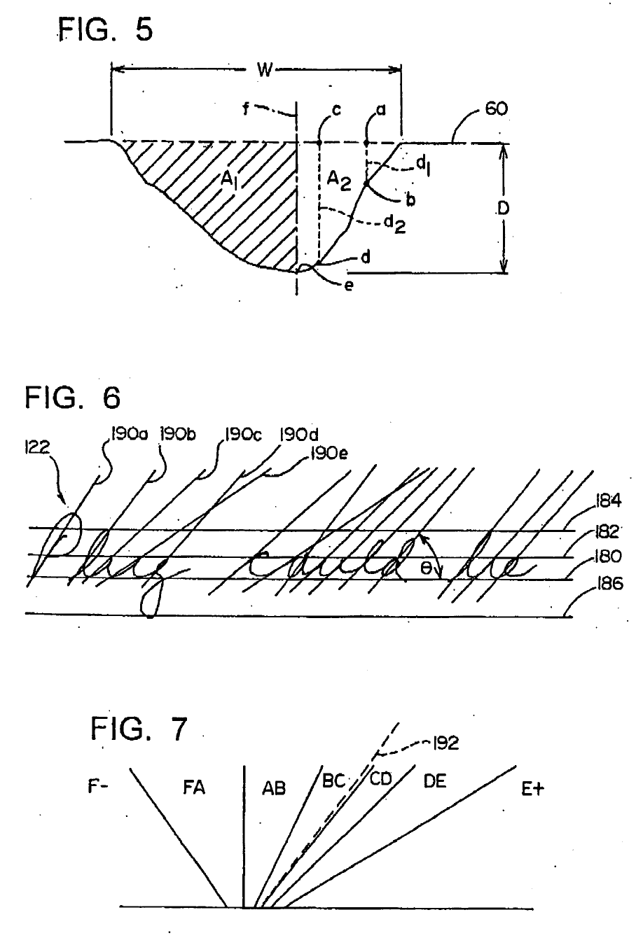

First, the way in which the maximum “height” or “depth” of the image is shifted or “skewed” towards one side or the other can indicate features of the source image. For example, in the context of a handwriting sample, these aspects of the analysis image may be associated with the direction in which the pen or other writing tool was held/tilted as the stroke was made. As can be seen in FIG. 5, this can be accomplished by determining the lowermost point or bottom “e” of the valley, and then calculating the areas A1 and A2 on either side of a dividing line “f” which extends upwardly from the bottom of the valley, perpendicular to the plane of the paper surface. That side having the greater area (e.g., A1 in FIG. 5) represents that side of the stroke on which the pressure of the pen/pencil point was greater, and therefore indicates which hand the writer was using to form the stroke or other part of the writing.

Second, the areas A1, A2 can be compiled and integrated over a continuous section of the writing. Furthermore, the line “f” can be considered as defining a divider plane or “wall” which separates the two sides of the valley, and the relative weights of the two sides can then be determined by calculating their respective volumes, in a manner somewhat analogous to filling the area on either side of the “wall” with water. For the convenience of the user, the “water” can be represented graphically during this step by using a contrasting color ( e.g., blue) to alternately fill each side of the “valley” in the 3-D display.

Third, by examining the “wings” and other features which develop where lines cross in the image, the operator can determine which one line was written atop the other or vice versa. This may allow a person analyzing handwriting to determine, for example, whether a signature was applied before or after a document was printed.

In any environment in which the analysis modules and methods of the present invention are used, these and other analytical tools may be used to illuminate features of the source image that are barely visible or not visible to the unaided eye.

III. Source Data Set

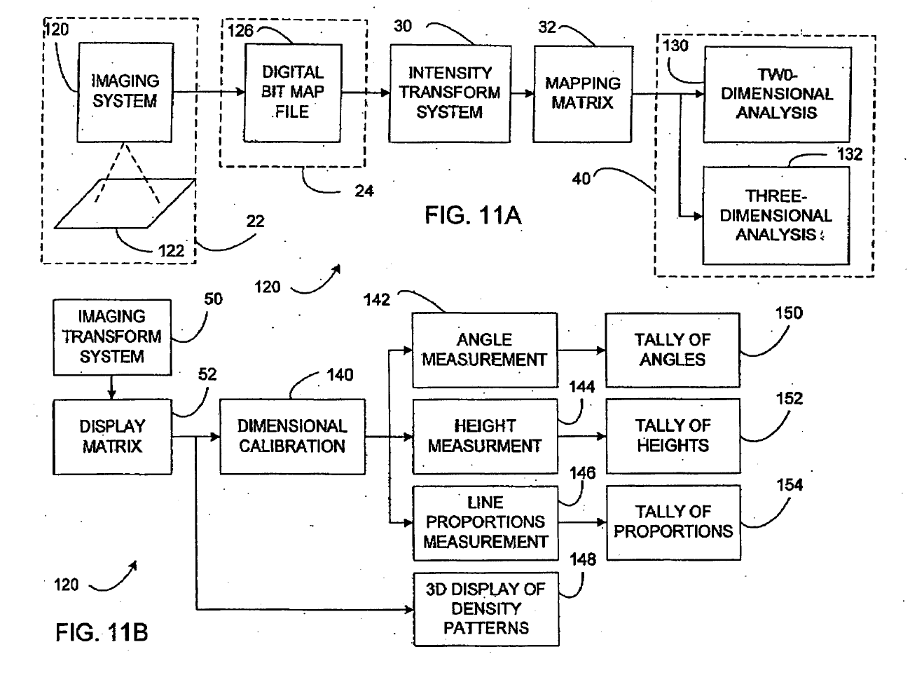

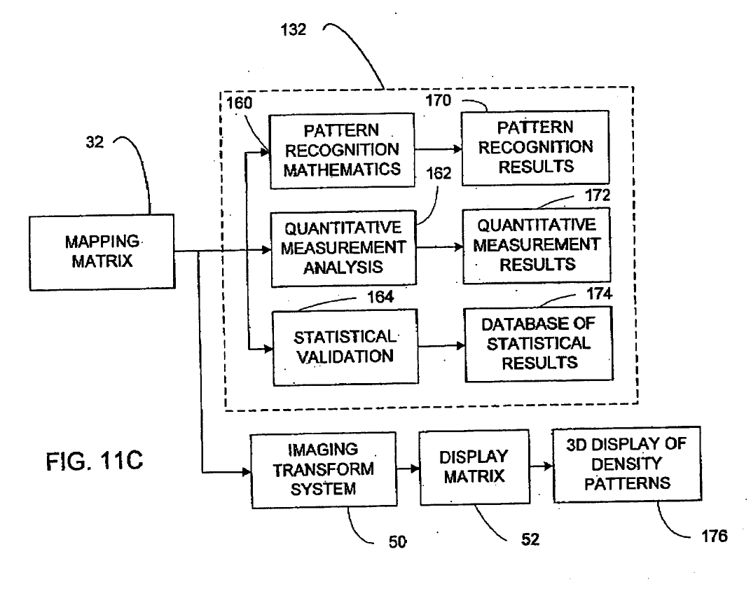

Referring now to FIG. 11 of the drawing, that figure contains a block diagram 120 that illustrates the sequential steps in obtaining and analyzing source images in accordance with one embodiment of the present invention as applied to handwriting analysis.

FIG. 11 illustrates that the source image data set 24 may be obtained by scanning the two-dimensional handwriting sample 122 using an imaging system 124. The analysis of handwriting samples will be referred to extensively herein because handwriting analysis illustrates many of the principles of the present invention. However, the source image may be any two-dimensional image and may be created in a different manner as will be described elsewhere herein. In the example shown in FIG. 11, the source image 22 is thus derived from a paper document containing handwriting.

In the context of a handwriting sample, the first step in the process implemented by the exemplary system 120 is to scan the handwriting sample 122 using the imaging system 124 such as a digital camera or scanner to create a digital bit-map file 126, which forms the source image data set 24. For accuracy, it is preferred that the scanner have a reasonably high level of resolution, e.g., a scanner having a resolution of 1,000 bpi has been found to provide highly satisfactory results.

These steps can be performed using conventional scanning equipment, such as a flatbed or hand-held digital scanner, which are normally supplied by the manufacturer with suitable software for generating bit-map files. For example, the imaging source 124 may produce a bit map image by reporting a digital gray scale value of 0 to 255. The variation in shade or color density from say 100 to 101 on such a gray scale is not detectable by the human eye, making for extremely smooth appearing continuous tone images whether on-screen or printed. With, typically, “0” representing complete lack of color or contrast (white) and “255” representing complete absorption of incident light (black), the scanner reports a digital value of gray scale for each dot per inch at the rated scanner resolution.

Typical resolution for consumer level scanners is 600 dpi. Laser printer output is nominal 600 dpi and higher, with inexpensive ink jet printers producing near 200 dpi. Nominal 200 dpi is fully sufficient to reproduce the image as viewed on the high-resolution computer monitor. While images are printed as they appear on-screen, type fonts typically print at higher resolution as a result of using font data files (True-Type, Postscript, etc) instead of the on-screen bitmap image. High-resolution printers may use multiple dots of color (dpi) to reproduce a pixel of on-screen bit map image.

Thus, if the imaging system 124 is a gray scale scanner used to scan a handwriting sample 122, the scanning process produces a source data set or “bit map image” 126, with each pixel or location on a two-dimensional coordinate system assigned a gray scale value representing the darkness of the image at that point on the source document. The software subsequently uses this image on an expanded scale to view each “dot per inch” more clearly.

Due to this scanning method, there is no finer detail available than the “single-dot” level. Artifacts as large as a single dot will cause that dot's gray scale value to be significant of that artifact. Artifacts much smaller than a single dot per inch will not be detected by the scanner. This behavior is similar to the resolution/magnification capabilities of an optical microscope. A typical pen stroke, when scanned at 600 dpi, will thus have on the order of 10 or more bits of gray scale data taken across the axis of the line. Referring again for a moment to FIG. 2, gray scale values may be “0” for the white paper background, increasing abruptly to some value, say 200, perhaps hold near 200 for several “dots” or pixels, and then decrease abruptly to “0” again as the edge of the line transitions to background white paper value.

The bit-map file 126 is next transmitted via a telephone modem, network, serial cable, or other data transmission link to the analysis platform, e.g., a suitable PC or Macintosh™ computer that has been loaded with software for carrying out the steps or functions of the intensity transform system 30 and analysis system 40 and storing the source image data set 24 and mapping matrix 32. The first step in the analysis phase, then, is to read in the digital bit-map file 126 which has been transmitted from the imaging system 124. The bit map file 126 is then processed to produce the mapping matrix 32 that, as will be described in separate sections below, may in turn be mathematically analyzed and/or converted into a two-dimensional analysis image for direct visual analysis.

In the exemplary system 120, the surface model is analyzed using an analysis system 40 comprising a two-dimensional analysis module 130 and a three-dimensional analysis module 132. Each of these modules 130 and 132 comprises separate steps or functions.

The two-dimensional analysis module 130 an three-dimensional analysis system 132 are used to create, measure, and analyze one or more analysis images that are derived from the surface model. It will be understood that it is easily within the ability of a person having an ordinary level of skill in the art of computer programming to develop software for implementing these and the following modules or method steps, using a PC or other suitable computer platform, given the descriptions and drawings which are provided herein.

Referring now to FIG. 11B, depicted in further detail therein is a block diagram representing the two-dimensional analysis module 130. FIG. 11B illustrates that the two-dimensional analysis module 130 comprises the imaging transform system 50, which generates the display matrix 52. In the exemplary analysis module 130, tools are provided to enhance the display and analysis of the display matrix 52.

In particular, the two-dimensional analysis module 130 employs a dimensional calibration module 140, an angle measurement module 142, a height measurement module 144, a line proportions measurement module 146, and a display module 148 for displaying 3D images representing density patterns and the like for use with the other modules 142, 144, and 146.

The dimensional calibration module 140 allows the user to calibrate the analysis module 130 such that measurements and the like are scaled to the actual dimensions of the sample 122.

The functions of the angle measurement module 142, height measurement module 144, and line proportions measurement module 146 will become apparent from the following discussion. These modules 142, 144, and 146 yield a tally of angles 150, a tally of heights 152, and a tally of proportions 154.

The three-dimensional analysis module 132 comprises a pattern recognition mathematics module 160, a quantitative measurement analysis module 162, a statistical validation module 164, and a display module 166 for displaying density patterns and the like associated with analysis functions of the modules 160, 162, and 164. For example, analysis of known mapping matrices may indicate that a certain type of pen is associated with certain patterns or quantitative measurements within mapping matrices. The modules 160, 162, and 164 generate results 170, 172, and 174 that indicate whether a given surface model matches the predetermined patterns or measurements.

IV. Display/Analysis of Surface Model

As was noted above, the display values (i.e., gray-scale/color density) of the source data set created by digitizing the source image are used for the third dimension to create the three-dimensional surface that highlights the density patterns of the original source image.

To represent three-dimensional space, the system 120 uses an x-y-z coordinate system. A set of points represents the image display space in relation to an origin point, 0,0. A set of axes x and y represent horizontal and vertical directions, respectively, of a two-dimensional reference coordinate system. Point 0,0 is the lower-left corner of the image (“southwest” corner) where the x- and y-axes intersect. When viewing in 2-D, or when first opening a view in 3-D (before doing any rotations), the operator will see a single viewing plane (the x-y plane) only.

In 3-D, an additional z-axis is used for points lying above and below the two-dimensional x-y plane. The x-y-z axes intersect at the origin point, 0,0,0. As is shown in FIGS. 3 and 4, the third dimension adds the elements of elevation, depth, and rotation angle. Thus, using a digital scanner coupled with a computer to process the data, similar plots of gray scale can be constructed 600 times per inch of line length (or more with higher resolution devices). Juxtaposing the 600 plots per inch produces an on-screen display or analysis image in which the original line appears similar to a virtual “mountain range”. If the plotted z-axis data is given negative values instead of positive, the mountain range appears to be a virtual “canyon” instead.

The representation is displayed as a three-dimensional surface in the form of a “mountain range” or “canyon” for visualization convenience; however, it will be understood that the display does not represent a physical gouge, or trench, or, in the context of handwriting analysis, a mound of ink upon the paper. To the 0contrary, the z-axis as shown by a “mountain range” or “canyon” itself does not directly depict a feature of the source image; the z-axis as described herein provides a spatial value to the source image that takes the place of the image values such as color or gray scale.

In the exemplary system 120, the coordinate system is preferably oriented to the screen, instead of “attached” to the 3-D view object. Thus, movement of the image simulates movement of a camera: as the operator rotates an object, it appears as if the operator is “moving the camera” around the image.

In a preferred embodiment, the positive direction of the x-axis goes to the right; the positive direction of the z-axis goes up; and the positive z-axis goes into the screen, away from the viewer, as shown in FIG. 3. This is called a “left-hand” coordinate system. The “left-hand rule” may therefore be used to determine the positive axis directions: positive rotations about an axis are in the direction of one's fingers if one grasps the positive part of an axis with the left hand, thumb pointing away from the origin.

Distinctively colored origin markers may also be included along the bottom edge of an image to indicate the origin point (0,0,0) and the end point of the x-axis, respectively. These markers can be used to help re-orient the view to the x-y plane after performing actions on the image such as performing a series of zooms and/or rotations in 3-D space.

Visual and quantitative analysis of the analysis images obtained from a two-dimensional handwriting sample can be carried out as follows, using a system and software in accordance with a preferred embodiment of the present invention.

A. Angle of “Mountain Sides”

Visual examples noted to date show that “steepness” of the mountain slopes is clearly visualized and expresses how sharp the edge of the line appears. Steeper corresponds to Sharper.

Quantitatively, the slope of a line relative to a baseline can be expressed in degrees of angle, rise/run, curve fit to an expression of the type y=mx+b, and in polar coordinates. In the context of handwriting analysis, the expression of slope can be measured along the entire scanned line length to arrive at an average value, standard deviation from the mean, and the true angle within a confidence interval, plus many other possible correlations.

B. Height of the “Mountain Range”

Visual examples show that height is directly related to the intensity or gray-scale or color density of source image. In the context of a line forming part of a handwriting sample, a dark black line results in a taller “mountain range” (or deeper “canyon”) as compared to light black or gray line created by a hard lead pencil line. Quantitative measurements of the mountain range height can be made at selected points, regions, or the entire length of the line. Statistical evaluation of the mean and standard deviation of the height can be done to mathematically establish the lines are the same or statistically different.

C. Variation in Height of the “Mountain Range”

Variations in “mountain range” height also may correspond to features of the source image. In the context of handwriting analysis, using the same instrument may reveal changes in pressure applied by the writer, stop/start points, mark-overs, and other artifacts.

Changes in height are common in the highly magnified display; quantification will show if changes are statistically significant and not within the expected range of height.

Each identified area of interest can be statistically examined for similarities to other regions of interest, other document samples, and other authors.

D. Width of the “Mountain Range” at the Base and the Peak

Visual examples show variations in width at the base of the “mountain range” that may correspond to features of the source image. In the context of handwriting analysis, variations in base width allow comparison with similar regions of text.

Quantification of the width can be done for selected regions or the entire line, with statistical mean and standard deviation values. Combining width with the height measurement taken earlier may reveal unique features of the source image; in the handwriting analysis example, these ratios tend to correspond to individual writing instruments, papers, writing surfaces, pen pressure, and others factors.

E. “Skewness” of the “Mountain Range”, Leaning Left or Right

A mountain range may appear to lean to the left or to the right when viewed as described herein. The “skewness” of a mountain range can correspond to features of the source image. In the analysis of handwriting samples, visual examples have displayed a unique angle for a single author, whether free-writing or tracing, while a second author showed visibly different angle while tracing the first author's writing.

Quantitative measurement of the baseline center and the peak center points can provide an overall angle of skew. A line through the peak perpendicular to the base will divide the range into two sides of unequal contained area, an alternative measure of skew value.

F. “Wings” or Ridges Appearing at Line Intersections

“Wings” or ridges may appear in lines or at intersections of lines in the source image. In handwriting analysis, visual examination has shown “wings” or ridges extending down the “mountainside”, following the track of the lighter density crossing line.

Quantitative measure of these “wings” can be done to reveal a density pattern in a high level of detail. The pattern may reveal density pattern effects resulting from the two lines crossing. Statistical measures can be applied to identify significant patterns or changes in density.

G. Sudden Changes in “Mountain Range” Elevation

Changes or discontinuities in “mountain range” elevation may also correspond to features of the source image. In the context of handwriting analysis, visual inspection readily reveals pen lifts, re-trace, and other effects correspond to sudden changes in “mountain range” elevation.

Quantitative measure of height can be used to note when a change is statistically significant, and identify the measure of the change. Similar and dissimilar changes elsewhere in the source image or document can be evaluated and compared.

H. Fill Volume of the “Mountain Range”

Fill volume of a “mountain range” can also correspond to features of the source image. Visual effects such as a flat bottom “canyon” created by felt tip marker, “hot spots” of increased color density (deeper pits in the canyon), and other areas of the canyon which change with fill (peninsulas, islands, etc.) have been recognized in handwriting samples.

Quantitative calculation of the amount of “water” required to fill the canyon can be done. Relating the amount (in “gallons”) to fill one increment (“foot”) over the entire depth of the “canyon” will reveal a plot of gallons per foot that will vary with canyon type. For instance, a square vertical wall canyon will require the same gallons per foot from bottom to top. A canyon with even 45° sloped walls will require two times as many gallons to fill each succeeding foot of elevation from bottom to top.

I. Isopleths Connecting Similar Image Values Along the “Mountain Range” Sides or “Canyon” Walls

Isopleths may be formed by connecting similar image values within the analysis image. Visually, the use of isopleths creates a analysis image having an appearance that is similar to a conventional topographic map. The use of isopleths representing levels on a “mountain range” or within a “canyon” is similar to the water fill analysis technique described above, but does not hide surface features as water level rises. Each isopleth on the topographical map is the similar to a beach or high-water mark left by a lake or pond.

Quantitatively a variety of measures could be taken to provide more information. For instance length of the isopleth, various distances horizontally and vertically measured, changes in direction with respect to one of the axes, and so on.

J. Color Value (RGB, Hue and Saturation) of Individual Dots.

The source image may include image values associated with colors, and these color image values may be used individually or together to generate the z-axis values of the surface model. In the context of handwriting analysis, quantitatively identifying the color value can provide valuable information, especially in the area of line intersections. In certain instances it may be possible to identify patterns of change in coloration that reveal line sequence information. Blending of colors, overprinting or obscuration, ink quality and identity, and other artifacts may also be available from this information.

Color can be an extremely valuable addition to the magnified display of the original source document.

V. Virtual Manipulation and Refinement of Analysis Image

Additional virtual manipulation and/or refinement of the analysis image can be carried out as follows by implementing one or more of the following techniques.

A. Smoothing/Unsmoothing the Image

A technique known in the art as smoothing can be used to soften or anti-alias the edges and lines within an image. This is useful for eliminating “noise” in the image.

B. Applying Decimation (Mesh Reduction) to an Image

In two-dimensional images using artistic techniques to represent a third dimension, an object or solid is typically divided into a series or mesh of geometric primitives (triangles, quadrilaterals, or other polygons) that form the underlying structure of the image. By way of illustration, this structure can be seen most clearly when viewing an image in wire frame, zooming in to enlarge the details.

Decimation is the process of decreasing the number of polygons that comprise this mesh. Decimation attempts to simplify the wire frame image. Applying decimation is one way to help speed up and simplify processing and rendering of a particularly large image or one that strains system resources.

For example, one can specify a 90%, 50%, or 25% decimation rate. In the process of decimation, the geometry of the image is retained within a small deviation from the original image shape, and the number of polygons used in the wire frame to draw the image is decreased. The higher the percentage of decimation applied, the larger the polygons are drawn and the fewer shades of gray (in grayscale view) or of color (in color scale view) are used. If the image shape cannot conform to the original image shape within a small deviation, then smaller polygons are retained and the goal of percentage decimation is not achieved. This may occur when a jagged, unsmoothed, image with extreme peaks and valleys is decimated.

The decimated image does not lose or destroy data, but recalculates the image data from adjacent pixels to reduce the number of polygons needed to visualize the magnified image. The original image shape is unchanged within a small deviation limit, but the reduced number of polygons speeds computer processing of the image.

When the analysis image is a forensic visualization of evidentiary images, decimation can be used to advantage for initially examining images. Then, when preparing the actual analysis for presentation, the decimation percentage can be set back to undo the visualization effects of the command.

C. Sub-Sampling an Image

The system displays an analysis image by sampling every pixel of the corresponding scan to build the surface model that is transformed into the display matrix that yields the analysis image. Sub-sampling is a digital Image-processing technique of sub-sampling every second, or third, or fourth pixel instead of sampling every pixel to form the analysis image. The number of pixels not sampled depends on the amount of sub-sampling specified by the user.

The resulting view results in some simplification of the image. Sub-sampling reduces image data file size to optimize processing and rendering time, especially for a large image or an image that strains system resources. In addition to optimizing processing, the operator can use more extreme sub-sampling as a method for greatly simplifying the view to focus on features at a larger-granular level of the image, as shown in this example.

When sub-sampling an image, fewer polygons are used to draw the image since there are fewer pixels defining the image. The more varied the topology of the image, the more likely that sub-sampling will not adequately render an accurate shape of the image. The lower the sub-sampling percentage, the fewer the number of pixels and the larger the polygons are drawn. Fewer shades of gray (in grayscale view) or of color (in color scale view) are used.

D. Super-Sampling an Image

Super-sampling is a digital image-processing technique of interpolating extra image points between pixels in displaying an image. The resulting view is a greater refinement of the image. It should be borne in mind that super-sampling generally increases both image file size and processing and rendering time.

When super-sampling an image, more image points and polygons are used to draw it. The higher the super-sampling percentage, the more image points are added, the smaller the polygons are drawn, and the more shades of gray (in grayscale view) or of color (in color scale view) are used. The geometry of the super-sampled image is not altered as compared to the pixel-by-pixel sampling at 100%.

E. Horizontal Cross-Section Transformation

Horizontal Cross-Section transformation creates a horizontal, cross-sectional slice (parallel to the x-y plane) across an isopleth.

F. Invert Transformation

Invert transformation inverts the isopleths in the current view, transforming virtual “mountains” into virtual “canyons” and vice versa.

For instance, when a written specimen is first viewed in 3-D, the written line may appear as a series of canyons, with the writing surface itself at the highest elevation, as in this example. In many cases, it may be easier to analyze the written line as a series of elevations above the writing surface. Invert transformation can be used to adjust the view accordingly, as in this example.

G. Threshold Transformation

The Threshold transformation allows the operator to set an upper and lower threshold for the image, filtering out values above and below certain levels of the elevation. The effect is one of filling up the “valley” with water to the lower contour level and “slicing” off the top of the “mountains” at that level. This allows the operator to view part of an isopleth or a section of isopleths more closely without being distracted by isopleths above or below those upper/lower thresholds.

VI. Two-Dimensional Display/Analysis

The method of the present invention also optionally provides for two-dimensional analysis of analysis images. When analyzed in two-dimensions, features of the analysis image are identified using one- or two-dimension geometric objects such as points, lines, circles, or the like. Often, the spatial or angular relationships between or among these geometric objects can illustrate features of the source image.

Two-dimensional analysis of analysis images is of particular value to the analysis of certain handwriting samples. Two of the principal measurements that can be carried out by the system of the present invention in this context are (a) the slant angles of the strokes in the handwriting, and (b) the relative heights of the major areas of the handwriting.

These angles and heights are illustrated in FIG. 6, which shows the handwriting sample 122 in more detail. The sample 122 has a base line 180 from which the other measurements are taken; in the example shown in FIG. 6, the base line 180 is drawn beneath the entire phrase in sample 122 for ease of illustration, but it will be understood that in most instances, the base line will be determined separately for each stroke or letter in the sample.

A first area above the base line, up to line 182 in FIG. 6 defines what is known as the mundane area, which extends from the base line to the upper limit of the lower case letters. The mundane area is considered to represent the area of thinking, habitual ideas, instincts, and creature habits, and also the ability to accept new ideas and the desire to communicate them. The extender letters continue above the mundane area, to an upper line 184 that defines the limit of what is termed the abstract area, which is generally considered to represent that aspect of the writer's personality which deals with philosophies, theories, and spiritual elements.

Finally, the area between base line 102 and the lower limit line 186 defined by the descending letters (e.g., “g”, “y”, and so on) is termed the material area, which is considered to represent such qualities as determination, material imagination, and the desire for friends, change, and variety.

The base line also serves as the reference for measuring the slant angle of the strokes forming the various letters. As can be seen in FIG. 6, the slant is measured by determining a starting point where a stroke lifts off the base line (see each of the upstrokes) and an ending point where the stroke ceases to rise, and then drawing one or more slant angle lines between these points and determining the angle θ to the base line. Examples of such slant angle lines are identified by reference characters 190a, 190b, 190c, 190d, and 190e in FIG. 6.

The angles are summed and divided to determine the average slant angle for the sample. This average is then compared with a standard scale, or “gauge”, to assess that aspect of the subject's personality which is associated with the slant angle of his writing. For example, FIG. 7 shows one example of a “slant gauge”, which in this case has been developed by the International Graphoanalysis Society (IGAS), Chicago, Ill. As can be seen, this is divided into seven areas or zones—“F−”, “FA”, “AB”, “BC”, “CD”, “DE” and “E+”—with each of these corresponding on a predetermined basis to some aspect or quality of the writer's personality; for example, the more extreme angles to the right of the gauge tend to indicate increasing emotional responsiveness, whereas more upright slant angles are an indication of a less emotional, more self-possessed personality. In addition, the slant which is indicated by dotted line 192 lies within the zone “BC”, which is an indication that the writer, while tending to respond somewhat emotionally to influences, still tends to be mostly stable and level-headed in his personality.

As described above with reference to FIG. 11B, the two-dimensional analysis module 130 may be implemented using the following methods. First, the digital bit-map file 126 from the scanner system 124 is displayed on the computer monitor for marking with the cursor. As a preliminary to conducting the measurements, the operator performs a dimensional calibration using the calibration module 140. This can be done by placing a scale (e.g., a ruler) or drawing a line of known length (e.g., 1 centimeter, 1 inch, etc.) on the sample, then marking the ends of the line using a cursor and calibrating the display to the known distance; also, in some embodiments the subject may be asked to produce the handwriting sample on a form having a pre-printed calibration mark, which approach has the advantage of achieving an extremely high degree of accuracy.

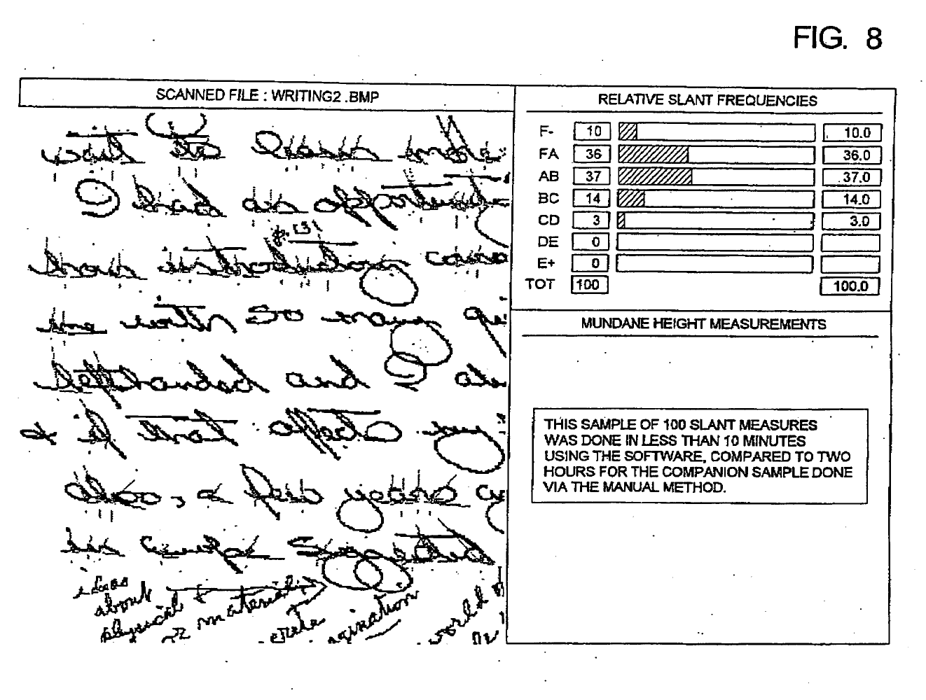

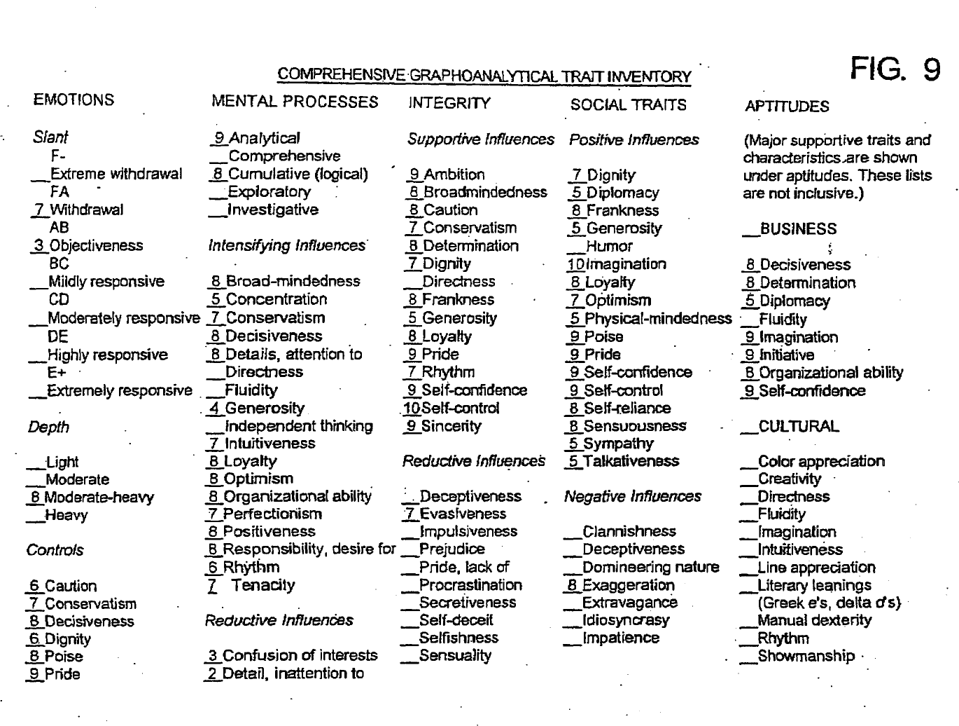

After dimensional calibration, the user takes the desired measurements from the sample, using a cursor on the monitor display as shown in FIG. 8. To mark each measurement point, the operator moves the cursor across the image which is created from the bit-map, and uses this to mark selected points on the various parts of the strokes or letters in the specimen.

To obtain the angle measurement 142, the operator first establishes the relevant base line; since the letters themselves may be written in a slant across the page, the slant measurement must be taken relative to the base line and not the page. To obtain slant measurements for analysis by the IGAS system, the base line is preferably established for each stroke or letter, by pinning the point where each stroke begins to rise from its lowest point.

In a preferred embodiment of the invention, the operator is not required to move the cursor to the exact lowest point of each stroke, but instead simply “clicks” a short distance beneath this, and the software generates a “feeler” cursor which moves upwardly from this location to the point where the writing (i.e., the bottom of the upstroke) first appears on the page. To carry out the “feeler” cursor function, the software reads the “color” of the bit-map, and assumes that the paper is white and the writing is black: If (moving upwardly) the first pixel is found to be white, the software moves the cursor upwardly to the next pixel, and if this is again found to be white, it goes up another one, until finally a “black” pixel is found which identifies the lowest point of the stroke. When this point is reached, the software applies a marker (e.g., see the “plus” marks in FIG. 8), preferably in a bright color so that the operator is able to clearly see and verify the starting point from which the base line is to be drawn.

After the starting point has been identified, the software generates a line (commonly referred to as a “rubber band”) which connects the first marker with the moving cursor. The operator then positions the cursor beneath the bottom of the adjacent downstroke (i.e., the point where the downstroke stops descending), or beneath next upstroke, and again releases the feeler cursor so that this extends upwardly and generates the next marker. When this has been done, the angle at which the “rubber band” extends between the two markers establishes the base line for that stroke or letter.

To measure the slant angle, the program next generates a second “rubber band” which extends from the first marker (i.e., the marker at the beginning of the upstroke), and the operator uses the moving cursor to pull the line upwardly until it crosses the top of the stroke. Identifying the end of the stroke, i.e., the point at which the writer began his “lift-off’ in preparation for making the next stroke, can be done visually by the operator, while in other embodiments this determination may be performed by the system itself by determining the point where the density of the stroke begins to taper off, in the manner which will be described below. In those embodiments which rely on visual identification of the end of the stroke, the size of the image may be enlarged (magnified) on the monitor to make this step easier for the operator.

Once the angle measuring “rubber band” has been brought to the top of the stroke, the cursor is again released so as to mark this point. The system then determines the slant of the stroke by calculating the included angle between the base line and the line from the first marker to the upper end of the stroke. The angle calculation is performed using standard geometric equations.

As each slant angle is calculated, this is added to the tally 150 of strokes falling in each of the categories, e.g., the seven categories of the “slant gage” shown in FIG. 7. For example, if the calculated slant angle of a particular stroke is 600, then this is added to the tally of strokes falling in the “BC” category. Then, as the measurement of the sample progresses, the number of strokes in each category and their relative frequencies is tabulated for assessment by the operator; for example, in FIG. 8, the number of strokes out of 100 falling into each of the categories FÄ, FA, AB, BC, CD, DE and E+ are 10, 36, 37, 14, 3, 0 and 0, respectively. The relative frequencies of the slant angles (which are principally an indicator of the writer's emotional responsiveness) are combined with other measured indicators to construct a profile of the individual's personality traits, as will be described in greater detail below.

The next step is to obtain the height measurements of the various areas of the handwriting using the height measurement block 144. The height measurements are typically the relative heights of the mundane area, abstract area, and material area. Although for purposes of discussion this measurement is described as being carried out subsequent to the slant angle measurement step, the system of the present invention is preferably configured so that both measurements are carried out simultaneously, thus greatly enhancing the speed and efficiency of the process.

Accordingly, as the operator pulls the “rubber band” line to the top of each stroke using the cursor and then releases the feeler cursor so that this moves down to mark the top of the stroke, the “rubber band” not only determines the slant angle of the stroke, but also the height of the top of the stroke above the base line. In making the height measurement, however, the distance is determined vertically (i.e., perpendicularly) from the base line, rather than measuring along the slanting line of the “rubber band”.

As was noted above, the tops of the strokes which form the “ascender letters” define the abstract area, while the heights of the strokes forming the lower letters (e.g., “a”, “e”) and the descending (e.g., “g”, “p”, “y”) below the base line determine the mundane and material areas. Differentiation between the strokes measured for each area (e.g., differentiation between the ascender letters and the lower letters) may be done by the user (as by clicking on only certain categories of letters or by identifying the different categories using the mouse or keyboard, for example), or in some embodiments the differentiation may be performed automatically by the system after the first several measurements have established the approximate limits of the ascender, lower, and descender letters for the particular sample of handwriting which is being examined.

As with the slant angle measurements, the height measurements are tallied at 152 for use by the graphoanalyst. For example, the heights can be tallied in categories according to their absolute dimensions (e.g., a separate category for each 1/16 inch), or by the proportional relationship between the heights of the different areas. In particular, the ratio between the height of the mundane area and the top of the ascenders (e.g., 2× the height, 2”×, 3×, and so on) is an indicator of interest to the graphoanalyst.

The depth measurement phase of the process, as indicated at block 146 in FIG. 11B, differs from the steps described above, in that what is being measured is not a geometric or dimensional aspect of each stroke (e.g., the height or slant angle), but is instead a measure of its intensity, i.e., how hard the writer was pressing against the paper when making that stroke. This factor in turn is used to “weight” the character trait which is associated with the stroke; for example, if a particular stroke indicates a degree of hostility on the part of the writer, then a darker, deeper stroke is an indicator of a more intense degree of hostility.

While graphoanalysts have long tried to guess at the pressure which was used to make a stroke so as to use this as a measure of intensity, in the past this has always been done on an “eyeball” basis, resulting in extreme inconsistency of results. The present invention eliminates such inaccuracies. In making the depth measurement, a cursor is used which is similar to that described above, but in this case the “rubber band” is manipulated to obtain a “slice” across some part of the pen or pencil line which forms the stroke.

Using a standard grey scale (e.g., a 256-level grey scale), the system measures the darkness of each pixel along the track across the stroke, and compiles a list of the measurements as the darkness increases generally towards the center of the stroke and then lightens again towards the opposite edge. The darkness (absolute or relative) of the pixels and/or the width/length of the darkest portion of the stroke are then compared with a predetermined standard (which preferably takes into account the type of pen/pencil and paper used in the sample), or with darkness measurements taken at other areas or strokes within the sample itself, to provide a quantifiable measure of the intensity of the stroke in question.

As is shown in FIG. 5, the levels of darkness measured along each cut may be translated to form a two-dimensional representation of the “depth” of the stroke. In this figure (and in the corresponding monitor display), the horizontal axis represents the linear distance across the cut, while the vertical axis represents the darkness which is measured at each point along the horizontal axis, relative to a base line 160 which represents the color of the paper (assumed to be white).

Accordingly, the two dimensional image forms a valley “v” which extends over the width “w” of the stroke. For example, for a first pixel measurement “a” which is taken relatively near the edge of the stroke, where the pen/pencil line is somewhat lighter, the corresponding point “d” on the valley curve is a comparatively short distance “d1” below the base line, whereas for a second pixel measurement “c” which taken nearer to the center of the stroke where the line is much darker, the corresponding point “d” is a relatively greater distance “d2” below the base line, and so on across the entire width “w” of the stroke. The maximum depth “D” along the curve “v” therefore represents the point of maximum darkness/intensity along the slice through the stroke.

As can be seen at block 154 in FIG. 11B, the depth measurements are tallied in a manner similar to the angle and height measurements described above for use by the graphoanalyst by comparison with predetermined standards. Moreover, the depth measurements for a series of slices taken more-or-less continuously over part or all of the length of the stroke may be compiled to form a three-dimensional display of the depth of the stroke (block 56 in FIG. 3), as which will be described in greater detail below.

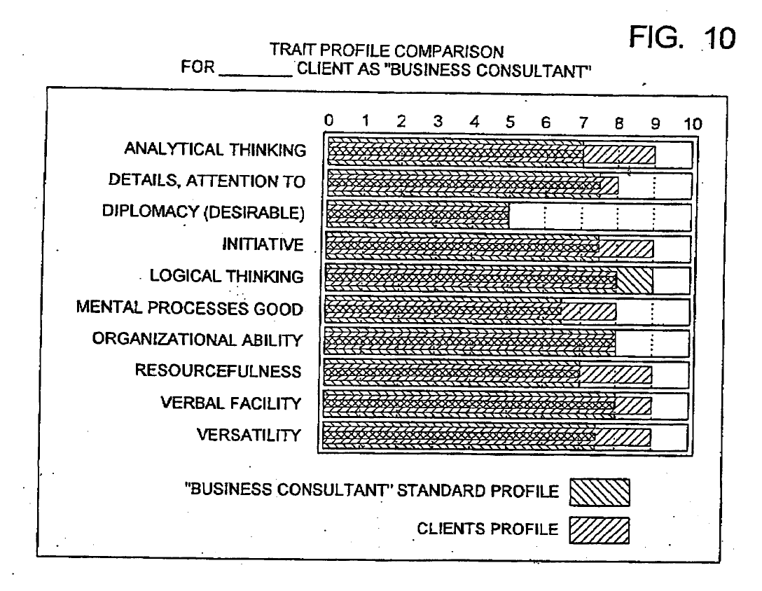

Referring to blocks 150, 152, and 154 in FIG. 11B, the system 120 thus assembles a complete tally of the angles, heights, and depths which have been measured from the sample. As was noted above, the graphoanalyst can compare these results with a set of predetermined standards so as to prepare a graphoanalytical trait inventory, such as that which is shown in FIG. 5, this being within the skill of a graphoanalyst having ordinary skill in the relevant art. The trait inventory can in turn be summarized in the form of the trait profile for the individual (see FIG. 10), which can then be overlaid on or otherwise displayed in comparison with a standardized or idealized trait profile.

For example, the bar graph 158 in FIG. 10 compares the trait profile which has been determined for the subject individual against an idealized trait profile a “business consultant”, this latter having been established by previously analyzing handwriting samples produced by persons who have proven successful in this type of position. Moreover, in some embodiments of the present invention, these steps may be performed by the system itself, with the standards and/or idealized trait profiles having been entered into the computer, so that this produces the trait inventory/profile without requiring intervention of the human operator.

VII. Examples of Image Analysis

This section discusses the application of the principles of the present invention to a number of environment-specific two-dimensional images to obtain a three-dimensional surface model. In the following examples, the mapping matrices defining the surface models employ a two-axis coordinate system and intensity values. In addition, these mapping matrices are converted into two-dimensional analysis images as described above. The two-dimensional analysis images described below use artistic methods such as perspective to depict the third dimension of the mapping matrices. Although the use of a two-dimensional analysis image is not required to implement the present invention in its broadest form, the analysis images reproduced herein graphically illustrate how the three-dimensional surface models emphasizes features of the source image that are not clear in the original source image.

The 2D or 3D image analysis and enhancement techniques described in Sections IV, V, and VI above with reference to handwriting analysis may be applied to the source images in other fields of study. Although different source images are associated with different physical things or phenomena, the images themselves tend to contain similar features. The 2D and 3D image analysis and enhancement techniques described above in the context of handwriting analysis thus also have application to images outside the field of handwriting analysis.

For example, the slope of a “canyon wall” of a source image may lead to one conclusion in the context of a handwriting sample and to another conclusion in the context of a mammography image, but similar tools can be used to analyze such slopes in both environments. One aspect of the present invention is thus to provide tools and analysis techniques that an expert can use to formulate rules and determine relationships associated with analysis images within that expert's field of expertise.

A. Medical Images

The diagnosis and treatment of human medical conditions often utilizes images created from a variety of different sources. The sources of medical images include optical instruments with a digital or photographic imaging system, ultrasonic imaging systems, x-ray systems, and magnetic resonance imaging systems. The images may be of the human body itself or portions thereof such as blood samples, biopsies, and the like. With some of these image sources, the image is recorded on a medium such as film; with others, the image is directly recorded using a transducer system that converts energy directly into electrical signals that may be stored in digital or analog form.

All of the medical source images described and depicted below are either created as or converted into a digital data file having a two-dimensional coordinate system and image values associated with points in the coordinate system. A number of medical images processed according to the principles of the present invention will be depicted and discussed below.

1. Mammography Images

Mammography images, or mammograms, are created by X-rays passing through breast tissues. The major tissues present in the breast structure include the fibroglandular, fibroseptal, and fatty tissues. The various breast tissue types have different density characteristics, and the degree of attenuation of the X-rays differs as they pass through different tissue types. The X-rays are thus attenuated as they pass through the tissue, with higher density tissue providing higher attenuation of the X-rays.

The X-rays are detected and recorded by film or a detector in a digital mammography unit; in either case, the level of X-ray exposure is detected, which results in the X-ray film or digital image typically referred to as a mammogram. The image is fully defined by scanning from side to side horizontally and top to bottom vertically.

A source image data set containing grayscale image values is obtained by scanning the film X-ray images using digital scanning devices. Alternatively, the source image data set can be obtained directly as a data stream from the digital mammography unit.

Referring now to FIG. 12, depicted therein are two mammogram or source images 220a and 220b and analysis images 222a and 222b generated from source image data sets associated with the source images 220. To generate the analysis images 222, the source image data sets, which have intensity or gray scale values plotted with respect to a reference x-y coordinate system, are transformed into mapping matrices as described above. The mapping matrices have in turn been transformed into display matrices having a third dimensional axis “z” plotted with respect to the reference x-y coordinate system. The display matrices have then been converted into analysis image data sets that are reproduced as the analysis images 222.

The Applicant has recognized that certain features indicative of medical anomalies are either invisible or difficult to detect in the original source images 220. In particular, a scanned image of a mammogram typically contains 256 shades of grayscale, but the human visual system is capable of discerning only approximately 30 individual grayscale shades. The unaided human eye thus cannot perceive image details within a mammogram that are within approximately four to six shades from each other.

While the grayscale changes may contain relevant information, this information simply cannot be detected by the unaided human eye. The systems and methods of the present invention significantly enhance the viewer's ability to discern features that are within imperceptibly narrow ranges of grayscale shades.

The Applicant has recognized that processing mammography images as described herein can highlight changes in calcium morphology within breast tissue; changes in calcium morphology are often associated with medical anomalies such as cancer. The increased ability to visualize grayscale shades thus offers the opportunity for early recognition of otherwise non-visible true density features associated with cancer. Early recognition of features such as changes in calcium morphology leads to early detection of the cancer, and early detection is often a key to cancer survival.

The use of the systems and methods of the present invention as an aid in mammography cancer detection provides a higher level of definition of the breast tissue density features and hence higher level of recognition by the radiologist. Breast tissue features can be monitored using X-ray mammography and related over time to normal aging (involutional) changes or to cancerous growth. Changes in breast tissue may include soft tissue changes such as increases in density, architectural distortions of the breast and supporting tissues, changes in mass proportions of the tissues, and skin changes.

Calcification accumulations have gained attention as a means of early recognition, based on characteristics of the accumulations. These characteristics include density value and patterns as shown in X-ray images, size and number of the accumulations, morphology of the calcifications, and pleiomorphism of the calcifications. Calcification presence and behavior can be classified as benign, indeterminate, or cancerous.

The exemplary analysis images 222 are displayed showing the z-axis as a third dimension, resulting in images having a 3D appearance. The resulting 3D images allow the examining radiologist to clearly identify and define features associated with all 256 shades of grayscale in the original source images 220.

In particular, the analysis images 222 depict a generally flat reference plane with mountain-like projections extending “upward” from this plane. The exemplary analysis images 222 are created by transforming grayscale density values directly into positive distance values that extend from the x-y reference plane defined by the source images 220. Color has been applied to the exemplary analysis images 222 such that each distance value is associated with a unique color from a continuous spectrum of colors. In addition, the analysis images 222 have been reproduced with perspective such that the analysis images 222 have a 3D effect; that is, the analysis images 222 have been “rotated” to make it appear as if the viewer's viewpoint has moved relative to the x-y reference plane.

Indicated at 224 in the analysis image 222b is a region where the colors change in a short distance. This color change in the analysis image 222b indicates an “altitude” change that is associated with a similar change in intensity or grayscale values. Comparing the region 224 of the analysis images 222 with a similar region 226 of the source image 220b makes it clear that these changes in intensity or grayscale values are not clear or even visually detectable in the source image 220b.

In addition, the Applicant believes that optical density, as represented by the z-axis dimension values, are associated with true density of the breast tissue. As generally discussed above, true density of breast tissue is an indicator of calcium morphology and possibly other features that in turn may correspond to medical anomalies such as breast cancer.

The analysis images 222 thus allow the viewer to see changes associated with tissue density, structure, mass proportions, and the like that may be associated with medical anomalies but which are not clearly discernable in the source images 220.

A given mammography source image may be analyzed on its own using the systems and methods of the present invention, or these systems and methods may be applied to a series of mammography source images taken over time. Comparison of two or more source images taken over time can illustrate changes in tissue density, structure, mass proportions and the like that are also associated with medical anomalies.

In addition to monitoring breast tissue density changes over time, the systems and methods of the present invention may be used in a surgical assist setting. The additional density definition provided by the present invention should enable more accurate determination of complete excision of cancerous tissue. Analysis images created using the present invention will be used to examine pathological x-ray of excised tissue and compared to conventional examination methods to identify and verify complete excision.

Another application of the systems and methods of the present invention to mammography images is to define a set of numerical rules representing image features associated with medical anomalies. For example, an oncologist may analyze analysis images of cancerous tissues for numerical relationships among cancerous tissues and features associated with the z-axis intensity values. These numerical relationships may be represented by suspect features such as the structural shapes of 3D “mountains”, “valleys”, “ridges”, or the like or changes in lines or other 2D shapes extending along or around 3D shapes. Such suspect features may be defined by, for example, fill volume, slope, peak height, line radius of curvature, line points of inflection, or the like. Such numerical rules would be similar to the quantification of fill volume (3D shapes) as described in Section IV(H) or line angle (2D shapes) as described in Section VI above.

Once a set of rules is defined, the surface model represented by the surface model may be numerically scanned for suspect features defined by the numerical rules. When the suspect features in a particular analysis image data set have been identified, these features may be tallied and statistically analyzed to reduce the possibility of chance occurrence and thereby increase the reliability of the numerical analysis.

Even further, if the numerical and/or statistical analysis of a particular multi-dimensional set indicates the presence of suspect features, that particular surface model may be converted into an analysis image data set and reproduced as an analysis image. An attending physician may review the analysis image and/or order more tests to confirm the presence or absence of the medical anomaly associated with the suspect image feature.

2. Pap Smear Images

A term “pap test” is a test for uterine cancer that examines cells taken as a smear (“pap smear”) from a cervix. The cells of a pap smear are commonly stained to enhance contrast and visual details for observation and diagnoses by the physician. Pap smears are examined using an optical microscope, commonly with a digital imaging system operatively connected thereto to record and display the microscope image. The image recorded by the imaging system can be used as a source image with the systems and methods of the present invention.

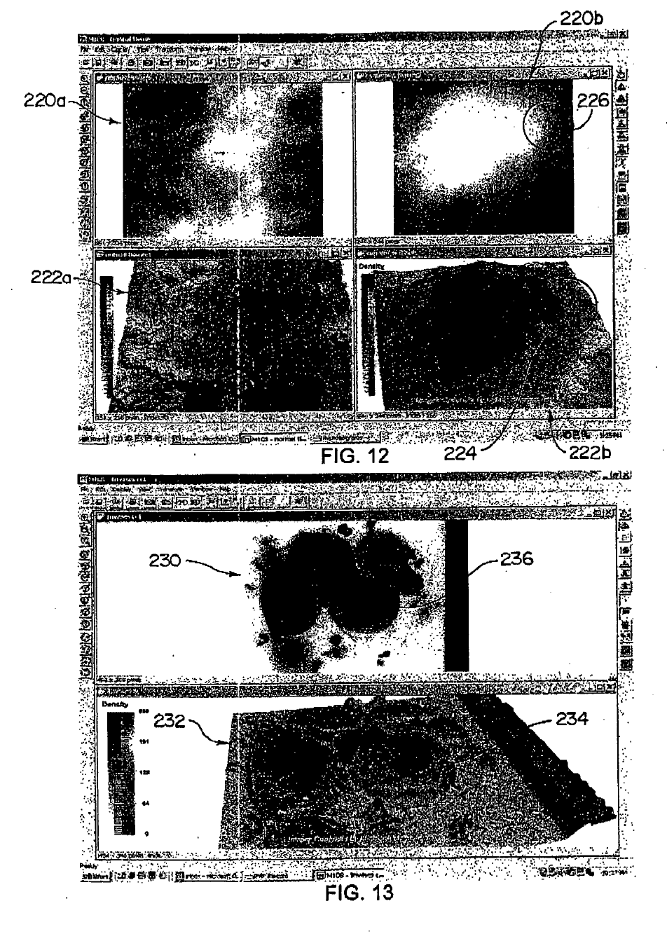

Referring now to FIG. 13, depicted therein is a pap smear source image 230 and an analysis image 232 generated from the source image data set associated with the source image 230. To generate the analysis image 232, the source image data set, which has intensity or gray scale values plotted with respect to a reference x-y coordinate system, is transformed into a surface model as described above. The surface model has in turn been transformed into a display matrix having a third dimensional axis “z” plotted with respect to the reference x-y coordinate system. The surface model is then converted into an analysis image data set that is reproduced as the analysis image 232.

The Applicant has recognized that certain features indicative of medical anomalies are either invisible or difficult to detect in the original source image 230 because the human visual system is capable of discerning among similar optical intensities. The unaided human eye thus cannot perceive image details within a pap smear image that are too close to each other in intensity. While the intensity changes may contain relevant information, this information simply cannot be detected by the unaided human eye. The systems and methods of the present invention significantly enhance the viewer's ability to discern features that are within narrow intensity ranges.

The use of the systems and methods of the present invention as an aid in pap smear analysis provides a higher level of definition of the cells of a pap smear. In particular, the analysis image 232 depicts a generally flat reference plane with mountain-like projections extending “upward” from this plane. The exemplary analysis image 232 is created by transforming grayscale density values directly into positive distance values that extend from the x-y reference plane defined by the source image 230. Color has been applied to the exemplary analysis image 232 such that each distance value is associated with a unique color from a continuous spectrum of colors. In addition, the analysis image 232 has been reproduced with perspective such that the analysis image 232 has a 3D effect; that is, the analysis image 232 has been “rotated” to make it appear as if the viewer's viewpoint has moved relative to the x-y reference plane.

Indicated at 234 in the analysis image 232 is a region where “mountain” peaks are indicated in red. These peaks indicate an “altitude” that is associated with a similar change in intensity or grayscale values. Comparing the region 234 of the analysis image 232 with a similar region 236 of the source image 230 makes it clear that these intensity or grayscale value peaks are not clear or even visually detectable in the source image 230.

The analysis image 232 thus allows the viewer to see changes associated with cellular tissue density, structure, mass proportions, and the like that may be associated with medical anomalies but which are not clearly discernable in the source image 230.

Another application of the systems and methods of the present invention to pap smear images is to define a set of numerical rules representing image features associated with medical anomalies. For example, an oncologist may analyze analysis images of cells indicating cervical cancer for numerical relationships among cancer-indicating cells and features associated with the z-axis intensity values. These numerical relationships may be represented by suspect features such as the structural shapes of 3D “mountains”, “valleys”, “ridges”, or the like or changes in lines or other 2D shapes extending along or around 3D shapes. Such suspect features may be defined by, for example, fill volume, slope, peak height, line radius of curvature, line points of inflection, or the like.

Once a set of rules is defined, the surface model may be numerically scanned for suspect features defined by the numerical rules. When the suspect features in a particular analysis image data set have been identified, these features may be tallied and statistically analyzed to reduce the possibility of chance occurrence and thereby increase the reliability of the numerical analysis.

Even further, if the numerical and/or statistical analysis of a particular multi-dimensional set indicates the presence of suspect features, that particular surface model may be converted into an analysis image data set and reproduced as an analysis image. An attending physician may review the analysis image and/or order more tests to confirm the presence or absence of the medical anomaly associated with the suspect image feature.

3. Retina Blood Vessel and Structure Images

Images of human eye retina blood vessels are commonly examined using an optical microscope, commonly with a digital imaging system operatively connected thereto to record and display the microscope image. Conventionally, the image of the retina is taken after a dye or tracer has been injected into the blood stream of the retina. The retina image recorded by the imaging system can be used as a source image with the systems and methods of the present invention.

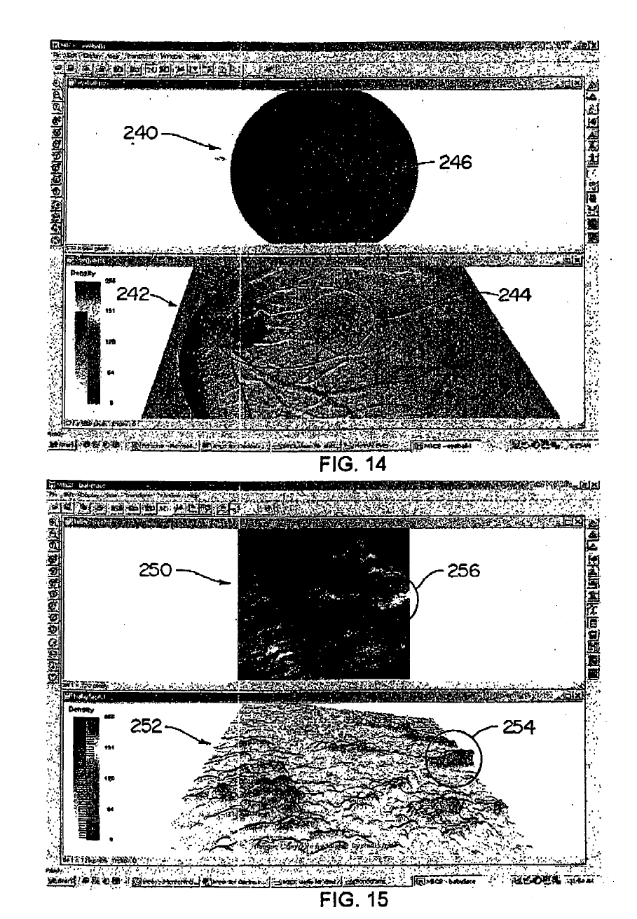

Referring now to FIG. 14, depicted therein is a retina source image 240 and an analysis image 242 generated from the source image data set associated with the source image 240. To generate the analysis image 242, the source image data set, which has intensity or gray scale values plotted with respect to a reference x-y coordinate system, is transformed into a surface model as described above. The surface model has in turn been transformed into a display matrix having a third dimensional axis “z” plotted with respect to the reference x-y coordinate system. The surface model is then converted into an analysis image data set that is reproduced as the analysis image 242.

The Applicant has recognized that certain features indicative of medical anomalies are either invisible or difficult to detect in the original source image 240 because the human visual system is incapable of discerning among similar optical intensities. The unaided human eye thus cannot perceive image details within a retinal image that are too close to each other in intensity. While the intensity changes may contain relevant information, this information simply cannot be detected by the unaided human eye. The systems and methods of the present invention significantly enhance the viewer's ability to discern features that are within narrow intensity ranges.

The use of the systems and methods of the present invention as an aid in retinal image analysis provides a higher level of definition of the retina. In particular, the analysis image 242 depicts a generally flat reference plane with ridge-like projections extending “upward” from this plane. The exemplary analysis image 242 is created by transforming grayscale density values directly into positive distance values that extend from the x-y reference plane defined by the source image 240. Color has been applied to the exemplary analysis image 242 such that each distance value is associated with a unique color from a continuous spectrum of colors. In addition, the analysis image 242 has been reproduced with perspective such that the analysis image 242 has a 3D effect; that is, the analysis image 242 has been “rotated” to make it appear as if the viewer's viewpoint has moved relative to the x-y reference plane.

Indicated at 244 in the analysis image 242 is a region where overlapping retinal blood vessels are illustrated in light green on a yellow background. Comparing the region 244 of the analysis image 242 with a similar region 246 of the source image 240 makes it clear that these overlapping blood vessels are not clearly visible in the source image 240.

The analysis image 242 thus allows the viewer to see changes associated with retinal structure and the like that may be associated with medical anomalies but which are not clearly discernable in the retina source image 240.

Another application of the systems and methods of the present invention to retinal images is to define a set of numerical rules representing image features associated with medical anomalies. These numerical relationships may be represented by suspect features such as the structural shapes of 3D “mountains”, “valleys”, “ridges”, or the like or changes in lines or other 2D shapes extending along or around 3D shapes. Such suspect features may be defined by, for example, fill volume, slope, peak height, line radius of curvature, line points of inflection, or the like.

Once a set of rules is defined, the surface model may be numerically scanned for suspect features defined by the numerical rules. When the suspect features in a particular analysis image data set have been identified, these features may be tallied and statistically analyzed to reduce the possibility of chance occurrence and thereby increase the reliability of the numerical analysis.

Even further, if the numerical and/or statistical analysis of a particular multi-dimensional set indicates the presence of suspect features, that particular surface model may be converted into an analysis image data set and reproduced as an analysis image. An attending physician may review the analysis image and/or order more tests to confirm the presence or absence of the medical anomaly associated with the suspect image feature.

4. Sonogram Images

Ultrasonic medical imaging systems use ultrasonic waves to form an image of internal body structures and organs. Ultrasound images, or sonograms, are commonly recorded and displayed by a digital imaging system that detects the ultrasonic waves. Sonograms recorded by the imaging system can be used as a source image with the systems and methods of the present invention.

Referring now to FIG. 15, depicted therein is an ultrasound source image 250 and an analysis image 252 generated from the source image data set associated with the source image 250. To generate the analysis image 252, the source image data set, which has intensity or gray scale values plotted with respect to a reference x-y coordinate system, is transformed into a surface model as described above. The surface model has in turn been transformed into a display matrix having a third dimensional axis “z” plotted with respect to the reference x-y coordinate system. The surface model is then converted into an analysis image data set that is reproduced as the analysis image 252.

The Applicant has recognized that certain features indicative of medical anomalies are either invisible or difficult to detect in the original source image 250 because the human visual system is incapable of discerning among similar optical intensities. The unaided human eye thus cannot perceive image details within a sonogram image that are too close to each other in intensity. While the intensity changes may contain relevant information, this information simply cannot be detected by the unaided human eye. The systems and methods of the present invention significantly enhance the viewer's ability to discern features that are within narrow intensity ranges.

The use of the systems and methods of the present invention as an aid in sonogram image analysis provides a higher level of definition of what is depicted in the sonogram. In particular, the analysis image 252 depicts yellow and green to blue mountain-like projections extending “upward” from a variegated white and tan reference plane. The exemplary analysis image 252 is created by transforming grayscale density values directly into positive distance values that extend from the x-y reference plane defined by the source image 250. Color has been applied to the exemplary analysis image 252 such that each distance value is associated with a unique color from a continuous spectrum of colors. In addition, the analysis image 252 has been reproduced with perspective such that the analysis image 252 has a 3D effect; that is, the analysis image 252 has been “rotated” to make it appear as if the viewer's viewpoint has moved relative to the x-y reference plane.

Indicated at 254 in the analysis image 252 is a region where a “peak” is indicated by a change from yellow, to green, to light blue, to dark blue. This peak is associated with a similar peak in intensity or grayscale values. Comparing the region 254 of the analysis image 252 with a similar region 256 of the source images 250 illustrates that the magnitude of these intensity or grayscale peaks is not clear in the source image 250.

The analysis image 252 thus allows the viewer to see changes associated with retinal structure and the like that may be associated with medical anomalies but which are not clearly discernable in the source image 250.

Another application of the systems and methods of the present invention to sonogram images is to define a set of numerical rules representing image features associated with medical anomalies. These numerical relationships may be represented by suspect features such as the structural shapes of 3D “mountains”, “valleys”, “ridges”, or the like or changes in lines or other 2D shapes extending along or around 3D shapes. Such suspect features may be defined by, for example, fill volume, slope, peak height, line radius of curvature, line points of inflection, or the like.

Once a set of rules is defined, the surface model may be numerically scanned for suspect features defined by the numerical rules. When the suspect features in a particular analysis image data set have been identified, these features may be tallied and statistically analyzed to reduce the possibility of chance occurrence and thereby increase the reliability of the numerical analysis.

Even further, if the numerical and/or statistical analysis of a particular multi-dimensional set indicates the presence of suspect features, that particular surface model may be converted into an analysis image data set and reproduced as an analysis image. An attending physician may review the analysis image and/or order more tests to confirm the presence or absence of the medical anomaly associated with the suspect image feature.

5. Dental Images

Dental X-rays are often taken of teeth for baseline reference, diagnostic, and pathology uses. Like mammograms, dental X-rays are recorded on film or directly using a digital detection system. Dental X-rays can be used as a source image with the systems and methods of the present invention.

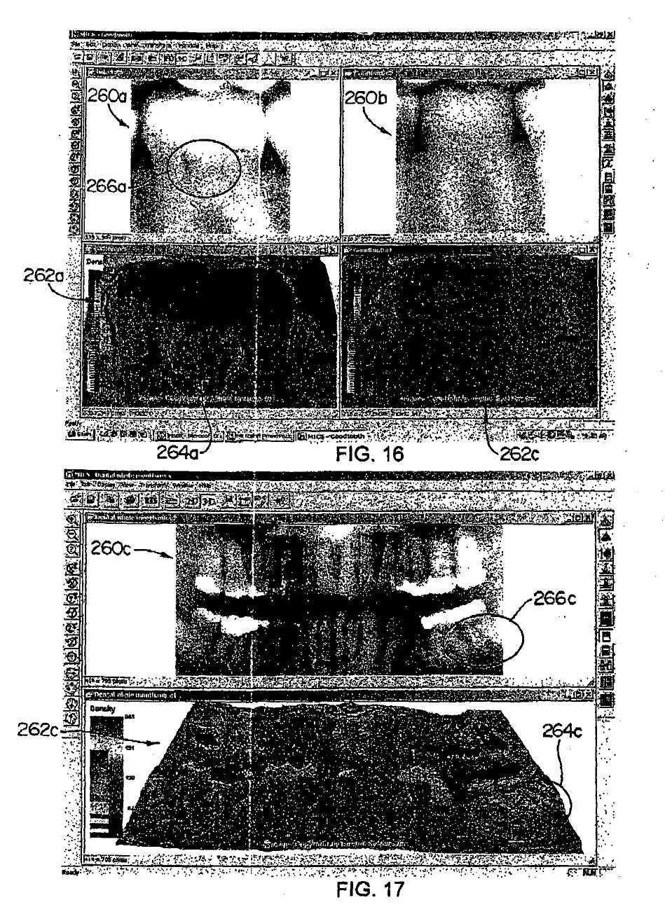

Referring now to FIGS. 16 and 17, depicted therein are dental X-ray images 260a, 260b, and 260c and analysis images 262a, 262b, and 262c generated from the source image data sets associated with the source images 260.

The source images 260a and 260b are bite-wing X-ray images representative of the type of image routinely obtained for baseline reference and diagnostic use. A bite wing X-ray is of a relatively small portion of the patient's dentition that produces a near life-size X-ray image. Source image 260cis a panorama X-ray image; a panorama X-ray image is a wide-field image taken of the patient's entire dentition in a single, continuous X-ray image. Panorama X-ray images are similar to bite-wing X-ray images but further maintain correct spatial orientation of all segments of the patient's dentition. The use of the systems and methods of the present invention with either bite-wing or panorama X-ray images result in greater than life-size scale and enhanced detail views of the image density. The source image data sets are converted into analysis image data sets that are reproduced as the analysis images 262.

The Applicant has recognized that certain features indicative of dental anomalies are either invisible or difficult to detect in the original source image 260 because the human visual system is incapable of discerning among similar optical intensities. The unaided human eye thus cannot perceive image details within a dental X-ray image that are too close to each other in intensity. While the intensity changes may contain relevant information, this information simply cannot be detected by the unaided human eye. The systems and methods of the present invention significantly enhance the viewer's ability to discern features that are within narrow intensity ranges.

The use of the systems and methods of the present invention as an aid in dental X-ray image analysis provides a higher level of definition of what is depicted in the dental X-ray. In particular, the analysis images 262a and 262b depict separate purple to blue and light green regions. The analysis image 262c depicts blue “plateaus” and yellow “valleys” with respect to gray “ridges”. The exemplary analysis images 262 are created by transforming grayscale density values directly into positive distance values that extend from the x-y reference plane defined by the source image 260. Color has been applied to the exemplary analysis images 262a and 262b such that each distance value is associated with a unique color from a continuous spectrum of colors. The analysis image 262c uses both color and gray scale to represent distance values.

In addition, the analysis images 262 have been reproduced with perspective such that they have a 3D effect; that is, the analysis images 262 have been “rotated” to make it appear as if the viewer's viewpoint has moved relative to the x-y reference plane.

Indicated at 264a in the analysis image 262a is a region containing irregularly shaped isopleths. These isopleths have been associated with density changes that are associated with tooth decay. Comparing the region 264a of the analysis image 262a with a similar region 266a of the source image 260a makes it clear that the changes in intensity or grayscale values associated with these isopleths are not visually detectable in the source image 260a.

Shown at 264c in the analysis image 262c is a region containing light blue lines that are associated with bone loss due to contact of the tooth with the jawbone. Comparing the region 264c of the analysis image 262c with a similar region 266c of the source image 260c makes it clear that the intensity or grayscale values associated with bone loss are not visually detectable in the source image 260a.

The analysis images 262 thus allow the viewer to see changes associated with tooth density, structure, and the like that may be associated with dental anomalies but which are not clearly discernable in the source images 260.

Dental features such as dentition and bone density variation patterns are unique to an individual person. These features are captured in dental X-ray images. X-ray images in the dental records of a known individual can be compared to similar images taken of human remains for the purpose of identifying the human remains. The systems and methods of the present invention can be used to create analysis images to facilitate the comparison of X-ray images from known and unknown sources to determine a match. In addition, a numerical analysis of an image from an unknown source with a batch of images from known sources may facilitate the process of finding likely candidates for a match.

Another application of the systems and methods of the present invention to dental X-ray images is to define a set of numerical rules representing image features associated with dental anomalies. These numerical relationships may be represented by suspect features such as the structural shapes of 3D “mountains”, “valleys”, “ridges”, or the like or changes in lines or other 2D shapes extending along or around 3D shapes. Such suspect features may be defined by, for example, fill volume, slope, peak height, line radius of curvature, line points of inflection, or the like.

Once a set of rules is defined, the surface model may be numerically scanned for suspect features defined by the numerical rules. When the suspect features in a particular analysis image data set have been identified, these features may be tallied and statistically analyzed to reduce the possibility of chance occurrence and thereby increase the reliability of the numerical analysis.

Even further, if the numerical and/or statistical analysis of a particular multi-dimensional set indicates the presence of suspect features, that particular surface model may be converted into an analysis image data set and reproduced as an analysis image. An attending dentist may review the analysis image and/or order more tests to confirm the presence or absence of the medical anomaly associated with the suspect image feature.

6. Arthritis/Osteoporosis Images

X-ray imaging is often used to detect the presence and progression of arthritis and osteoporosis, and such images may also be used as a source image with the systems and methods of the present invention.

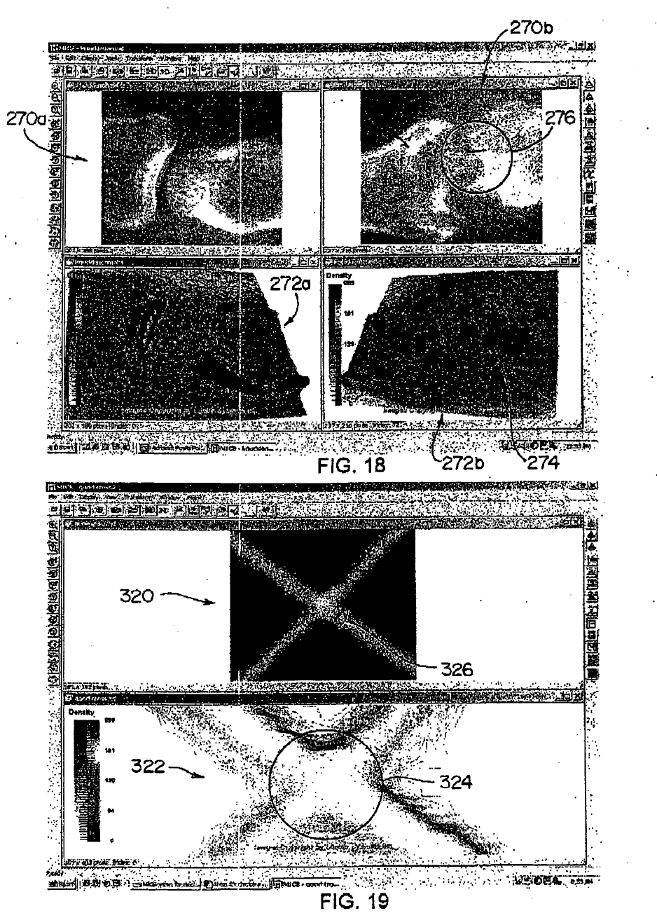

Referring now to FIG. 18, depicted therein are dental X-ray images 270a and 270b and analysis images 272a and 272b generated from the source image data sets associated with the source images 270.

The Applicant has recognized that certain features indicative of the presence and progression of arthritis and osteoporosis are either invisible or difficult to detect in the original source image 270 because the human visual system is incapable of discerning among similar optical intensities. The unaided human eye thus cannot perceive image details within an X-ray image that are too close to each other in intensity. While the intensity changes may contain relevant information, this information simply cannot be detected by the unaided human eye. The systems and methods of the present invention significantly enhance the viewer's ability to discern features that are within narrow intensity ranges.

The use of the systems and methods of the present invention as an aid in X-ray image analysis provides a higher level of definition of what is depicted in the X-ray. In particular, the analysis images 272a and 272b depict curved blue to purple “mountains” along a green “plateau”. The exemplary analysis images 272 are created by transforming grayscale density values directly into positive distance values that extend from the x-y reference plane defined by the source image 270. Color has been applied to the exemplary analysis images 272a and 272b such that each distance value is associated with a unique color from a continuous spectrum of colors.

In addition, the analysis images 272 have been reproduced with perspective such that they have a 3D effect; that is, the analysis images 272 have been “rotated” to make it appear as if the viewer's viewpoint has moved relative to the x-y reference plane.

Indicated at 274b in the analysis image 272b is a light blue area associated with increased calcium deposits associate with arthritis. Comparing the region 274b of the analysis image 272b with a similar region 276b of the source image 270b makes it clear that calcium deposits are associated with intensity or grayscale values that are not clear in the source image 270b.

The analysis images 272 thus allow the viewer to see changes associated with bone density, structure, and the like that may be associated with arthritis and osteoporosis but which are not clearly discernable in the source images 270.

Another application of the systems and methods of the present invention to X-ray images is to define a set of numerical rules representing image features associated with medical anomalies. These numerical relationships may be represented by suspect features such as the structural shapes of 3D “mountains”, “valleys”, “ridges”, or the like or changes in lines or other 2D shapes extending along or around 3D shapes. Such suspect features may be defined by, for example, fill volume, slope, peak height, line radius of curvature, line points of inflection, or the like.

Once a set of rules is defined, the surface model may be numerically scanned for suspect features defined by the numerical rules. When the suspect features in a particular analysis image data set have been identified, these features may be tallied and statistically analyzed to reduce the possibility of chance occurrence and thereby increase the reliability of the numerical analysis.

Even further, if the numerical and/or statistical analysis of a particular multi-dimensional set indicates the presence of suspect features, that particular surface model may be converted into an analysis image data set and reproduced as an analysis image. An attending physician may review the analysis image and/or order more tests to confirm the presence or absence of the medical anomaly associated with the suspect image feature.

B. Forensic Images

Forensic investigation often utilizes images created from a variety of different sources. Although handwriting analysis as discussed above can have significant non-forensic uses, handwriting analysis may be used as a forensic analysis technique. The sources of forensic images are primarily scanners or optical instruments with a digital or photographic imaging system, but other imaging systems may be used as well. The images may be of a wide variety of types of evidence that must be identified and/or matched. With some of these image sources, the image is recorded on a medium such as film; with others, the image is directly recorded using a transducer system that converts energy directly into electrical signals that may be stored in digital or analog form.

All of the forensic source images described and depicted below are either created as or converted into a digital data file having a two-dimensional coordinate system and image values associated with points in the coordinate system. A number of forensic images processed according to the principles of the present invention will be depicted and discussed below.

1. Forensic Document Images

The examination of documents for forensic purposes is widespread. Forensic document images are typically formed by scanning a document of interest using conventional scanning techniques which produce a digital data file that may be used as a source image data set. The source image data set typically contains grayscale or color image values.

Referring now to FIGS. 19-26, depicted therein are a number of forensic document source images 320a, 320f, 320g, 320h, and 320i and analysis images 322a, 322b, 322c, 322d, 322e, 322f, 322g, 322h, 322i. The analysis images 322a, 322f, 322g, 322h, and 322i are generated from source image data sets associated with the source images 320a, 320f, 320g, 320h, and 320i, respectively. The source images associated with the analysis images 322b, 322c, 322d, and 322e are not shown.

The Applicant has recognized that certain features of forensic documents are either invisible or difficult to detect in the original source images 320. In particular, a scanned image typically contains 256 shades of grayscale or 256 shades of red, green, and blue in a color image; however, the human visual system is not capable of discerning subtle differences between shades in an image. The unaided human eye thus cannot perceive image details in many documents that are to be analyzed forensically.

Accordingly, while the intensity changes may contain relevant information, this information cannot be detected by the unaided human eye. The systems and methods of the present invention significantly enhance the viewer's ability to discern features that are within imperceptibly narrow ranges of intensity shades.

The exemplary analysis images 322 are displayed showing the z-axis as a third dimension, resulting in images having a 3D appearance. The resulting 3D images allow the forensics expert to clearly identify and define features associated with all 256 shades of grayscale in the original source images 320.

a. Intersecting Lines

The analysis image 322a in FIG. 19 depicts two intersecting lines for the purpose of visualizing the sequence of line formation. The sequence of line formation can often reveal the interaction of the instruments, whether hand operated or machine, that formed the lines of the source image 320a. The systems and methods of the present invention generate analysis images, such as the image 322a, that facilitate the examination of the sequence in which lines are formed on printed or handwritten documents.

Indicated at 324 in the analysis image 322 are isopleths associated with shifts of optical density of ink that correspond to one line being formed over another line later in time. Comparing the region 324 of the analysis image 322 with a similar region 326 of the source image 320 makes it clear that these shifts in optical density are not clear in the source image 320.

b. Copy Generations

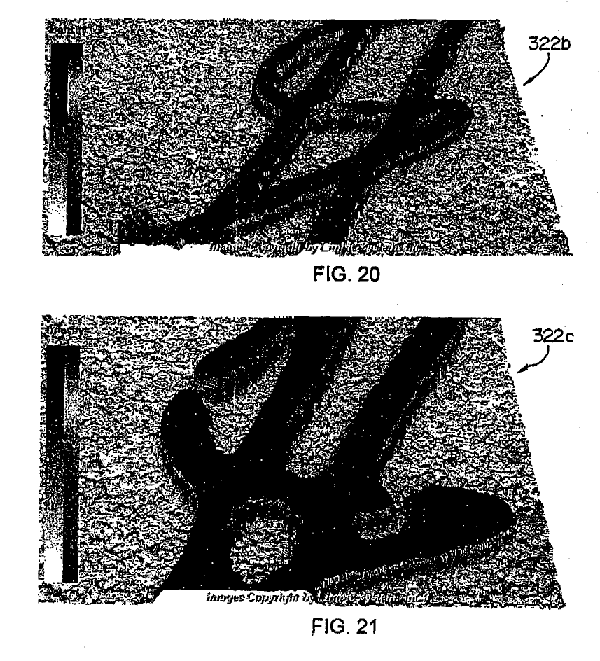

The analysis images 322b and 322c in FIGS. 20 and 21 depict lines or characters that have been reproduced on a photocopy machine using an analog (xerography) reproduction process. Such photocopy machines are limited in the precision with which they can reproduce a copy of the original image. These limitations cause the copy to differ from the original in known and predicable ways.

For example, the photocopy machine has a default threshold level of detection of grayscale levels. If the original is lighter gray than the threshold, then nothing is printed on the copy. If the original is darker gray than the threshold, then black is printed on the copy. Analog photocopy machines thus do not accurately reproduce shades of gray on first and subsequent copy generations. Limitations in detail resolution cause a gradual shape-shifting degradation of image quality in each copy generation.

The analysis image 322b depicts a first generation copy of a pen and ink drawing, while the analysis image 322c depicts a ninth generation copy of the same pen and ink drawing. A comparison of the analysis images 322b and 322c illustrates the differences in copy generations.

The analysis images 322d and 322e depicted in FIG. 22 are analysis images of an original gray scale image printed on an ink jet printer and a second generation copy of that gray scale image, respectively. A comparison of these images 322d and 322e indicates differences associated with copy generation.

c. Pen Type Visualization

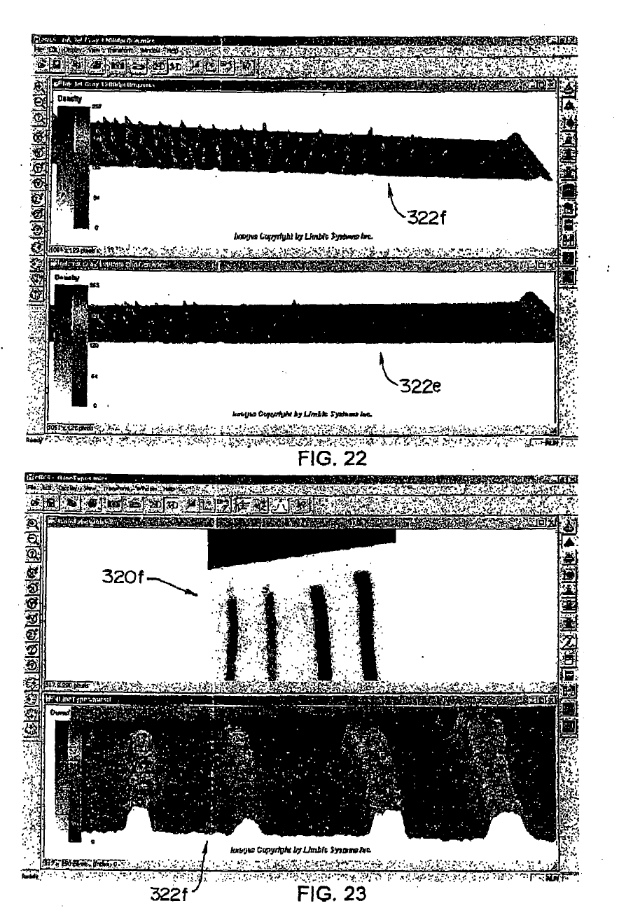

The analysis images 322f and 322g depicted in FIGS. 23 and 24 illustrate features associated with different types of writing instruments.

The analysis image 322f is created from the source image 320f, which contains lines 324 formed by pens using different types of ink. In particular, lines 324a and 324b are formed by ballpoint pens using a paste style ink (e.g., common Bic pen), while lines 324c and 324d are formed by felt-tip markers using free-flowing liquid inks (e.g., Magic Marker). The density profiles of all ballpoint pens are similar, as are the density profiles of all felt-tip markers. The differences between pen types are illustrated in the analysis image 322f by different levels and colors of the “mountain” heights.

In addition, ballpoint pens commonly produce light streaks or striations in the written line. These like streaks can often be used to determine direction of travel of the pen and retracing, hesitation, and other forensic clues to the creation of the writing. The striations in the written line are more visible in the analysis image 322g.

d. Watermarks

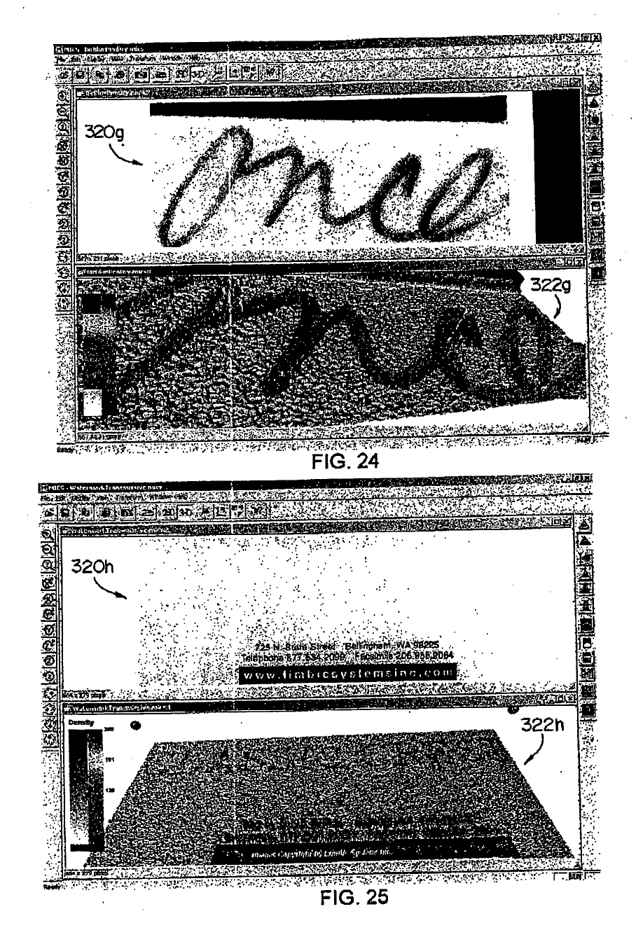

Watermarks are patterns embedded in paper during manufacture. Watermarks are visualized by light transmitted through a watermarked paper document. The source image 320h in FIG. 25 depicts a watermark that has been scanned with a scanner having transmissive light scanning capability. The analysis image 322h illustrates that the watermark is more pronounced when processed using the systems and methods of the present invention.

e. Paper Types

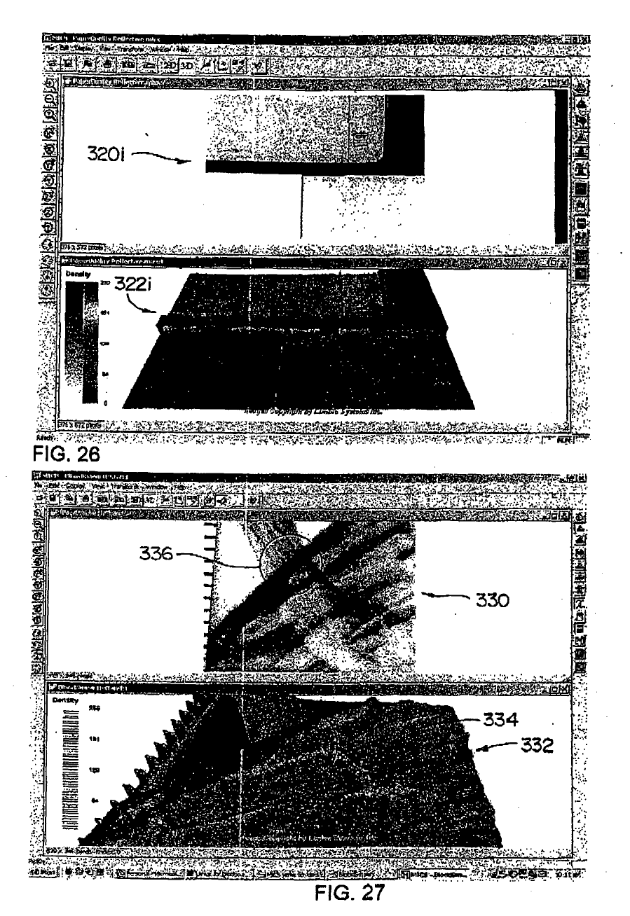

Surface textures and coloration of various paper types can be digitized with a scanner and visualized using the systems and methods of the present invention. The source image 320i in FIG. 26 contains gray scale density pattern variations that are rendered more pronounced and clear in the analysis image 322i.

2. Blood Splatter and Smear Images

The examination of blood splatter and blood smear is commonly used in forensic investigation. Blood splatter can indicate the direction of travel of a blood droplet, while blood smear can indicate subsequent wiping or brushing against blood on a surface. Determining the direction of travel of a blood droplet and/or whether blood on a surface was smeared can provide vital clues for crime and accident investigations.

The source image 330 in FIG. 27 illustrates blood splatter and subsequent smear. In particular, indicated at 334 in the analysis image 322 are ridges associated with direction of travel of blood droplets. Comparing the region 334 of the analysis image 332 with a similar region 336 of the source image 320 makes it clear that these ridges are not clear in the source image 320.

3. Fingerprint Images

Fingerprints are a unique identifying characteristic of individuals. The examination of fingerprints is thus commonly used in forensic investigation to identify persons who were present at a crime or accident scene.

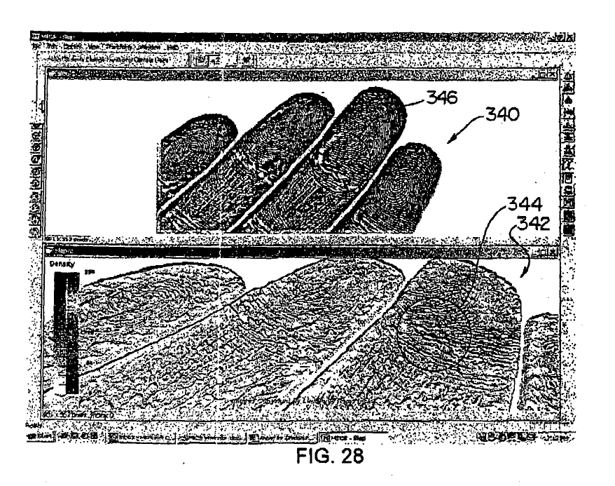

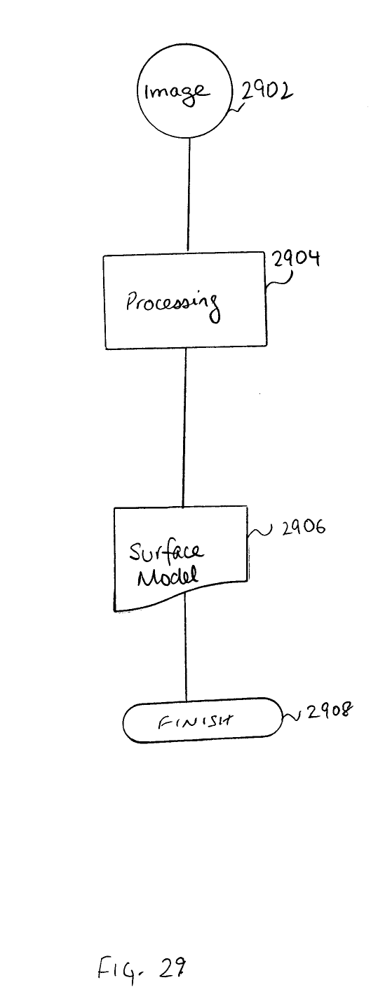

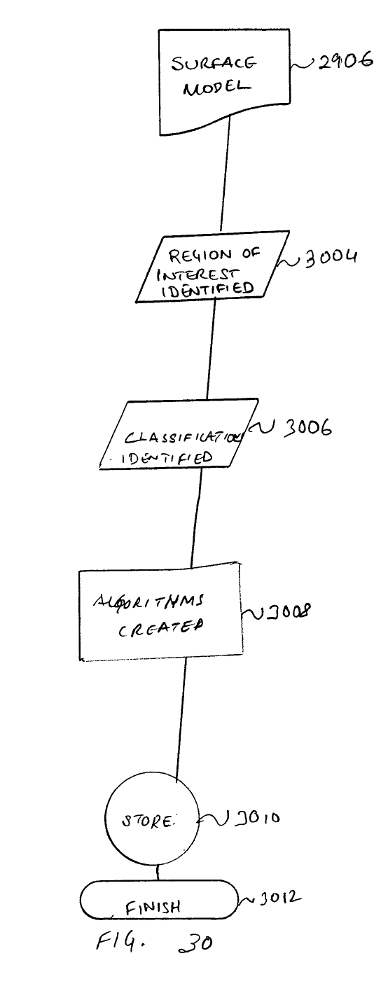

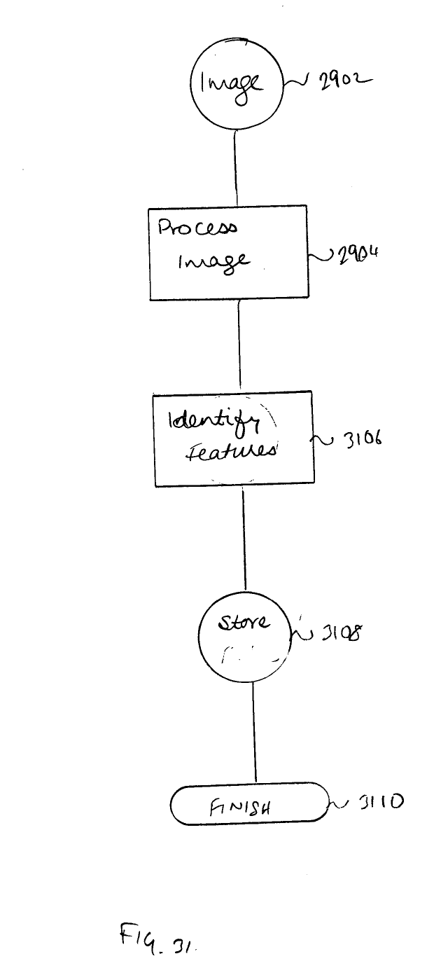

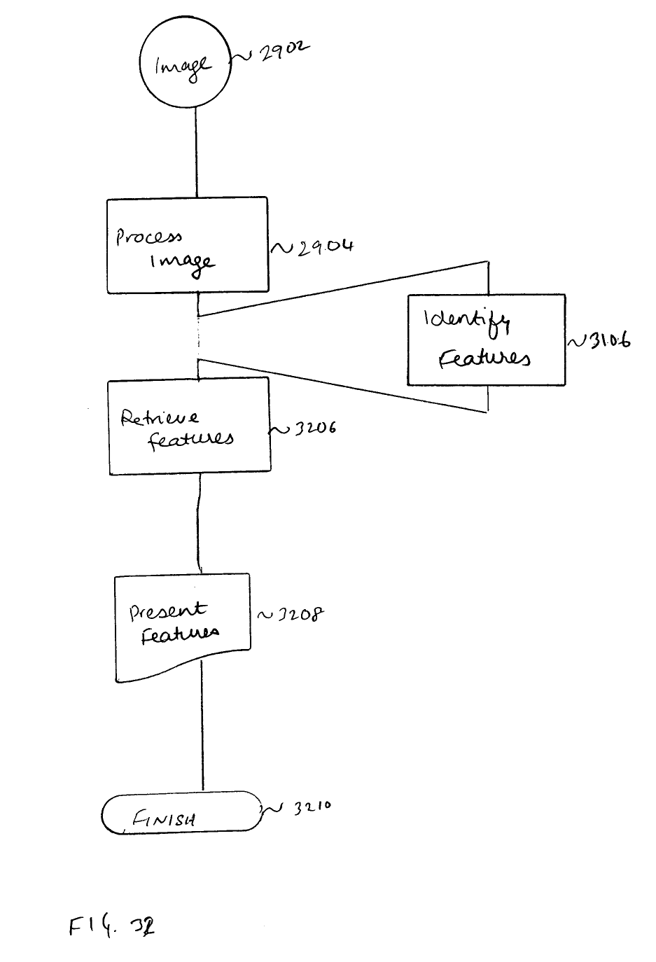

The source image 340 in FIG. 28 is of a fingerprint, and the analysis image 342 illustrates how the systems and methods of the present invention can be used to illustrate features that are not clear in the source image 330.

In particular, as shown at 344 in the analysis image 342 are fingerprint features associated with the concepts of “ridgeology” and “poroscopy” as used in fingerprint analysis. Comparing the region 344 of the analysis image 342 with a similar region 346 of the source image 340 makes it clear that certain features of the fingerprint in the source image 340 are highlighted in the analysis image 342.

VIII. Creating and Using a Database of Image Classifications and Features

As described in detail above, a human eye is typically capable of discerning approximately 30 shades or intensities of a color. However, a computer may be able to discern nearly an infinite number of shades. The technique disclosed herein enables the creation of algorithms and rules to identify certain characteristics in an image based on shade differences that are not discernable by a human eye. For example, given an image of eight bits, up to 256 intensities or shades of a color may appear in the image. The shades that a viewer cannot discern by eye alone may present information relating to the underlying object from which the image was created. When a computer is able to discern the shade or intensity differences and present these differences to a user in a meaningful manner, it may become possible to create enhanced algorithms or rules for locating identifying information in an image and matching images with this information. The following non-exhaustive list of examples illustrate some information that may become available. Subtle differences in shades or intensities in mammograms may identify whether a tumor is malignant or benign. In a baggage scan, it may be possible to differentiate between putty and an explosive depending on subtle differences in shades. In a weld, subtle shade differences may indicate an impending weld failure.

Using the extra information available in the now-perceptible image intensities, it may become possible to create classifications of image features. A classification may include a least inconsistent set of information such that a probability is greatest that the set defines an underlying object uniquely. When a classification is created, it may include spatial and temporal bases. A spatial classification may include distances or other relationships between various parts of a provided image or features identified therein. A temporal classification may include differences that are presented over time. As an example, a line appearing in an analyzed image that grows longer and darker over time may indicate the presence of a critical weld failure. Genetic algorithms or neural network algorithms may be used to create classifications or identify features in accordance with the previously created classifications. One skilled in the art would recognize what genetic algorithms and neural networks are and would know how to implement the disclosed system using these and other types of algorithms.

Using the techniques described herein, classifying domain-specific data across a spectrum of images within a relevant field is made possible. A database may then be created with image features identified in accordance with such a classification to enable further storing, searching, and analysis. In creating a database, a sample of images in a given field would be used. The more images that are provided, the better the system will likely be at identifying matches. The technique may be added to matching or analysis systems that already exist. The technique may be applicable in a variety of fields, including fingerprint analysis, oncology, odontology, thermal image analysis, baggage scanning, mammography, gemology, geo-spatial mapping, and weld analysis. The system would be capable of being used in areas where there are or are not matching or diagnosis algorithms and systems already in place.

An analyst may analyze a three dimensional surface model generated by the system to identify new features that were unrecognizable in the two dimensional image used to create the surface model. For example, existing fingerprint analysis defines ridge morphology, whereby, for example, the system identifies a ridge and/or bifurcation, then moves three ridges over to identify another fingerprint feature. Using the disclosed system, the user or analyst can analyze smaller fingerprint features, such as pores, and from these smaller features, develop rules or algorithms. Using this system, an analyst may, e.g., determine that he or she may not need to move over three ridges, but possibly only a single ridge, to identify sufficient distinguishing characteristics that would differentiate one partial fingerprint image from another. From this analysis, the system or the user creates classifications for rules. The user may either create the classifications manually or add enough interconnecting examples such that probabilities are sufficiently great to heuristically distinguish between two features in the provided images. The system or the user creates matching or classification algorithms to analyze the identifying features in the images. Thereafter, these algorithms may be input into an existing automatic fingerprint identification system, and the system may then search or match existing fingerprints using the new algorithms and rules to improve upon the existing fingerprint identification system. The user or analyst is able to create enhanced classifications as a result of being able to discern additional information that is presented by the system in a surface model that was created from an image. As previously stated, such additional information was not previously discernable by the human without use of the system.

As another example, weld failures may be analyzed. A database of weld morphology may be created and analyzed by a human to identify differences in features between good and bad welds based on image analyses overtime. The information may be analyzed spatially, temporally, or both.

The system may receive an image and automatically find previously added images from the database that have similar characteristics or features in accordance with the stored classifications. Alternatively, the system, provided with an image, receives further input from a user on features that may uniquely identify the image. The system may then search for these features in the database. The user may then compare images found by the system to determine whether there is a match. Alternatively, the system determines matches automatically.

Creation and use of an empirical database enables at least two processes. The first process is improved human understanding. Human decision makers, such as radiologists, fingerprint analysts, and luggage screeners can access the database for comparison and analytical purposes. A second process that is made possible is increased machine vision. Using the database, images or features stored in imaging systems can scan an image, measure intensity values and identify other unique features, and compare these with the stored samples. The system may then generate a report indicating matches with previously stored images and features. As an example, the system may identify to the user that there may be plastic explosives in a given bag. Alternatively, the system may analyze changes in image intensity data over a period of time and identify whether a tumor is benign or malignant.

A result of a sample set analysis may be a database that correlates image intensity information with known features or characteristics. The database may be constructed heuristically such that correlations and patterns may be continually refined as new images are added and image intensity information is analyzed.

The system database can be created with a variety of commercially available database packages, such as DB2, Oracle, or SQL Server, or may be a proprietary database format. One skilled in the art would understand that various database vendors or formats can be used without limiting the techniques presented.

The techniques disclosed herein may be used to create a new system. As an example, a new database of weld failures may be created. Alternatively, the techniques disclosed herein may be used in an existing system. As examples, the techniques may be used to extend the capabilities of an existing baggage screening system or an automatic fingerprint identification system.

FIG. 29 is an illustration of an embodiment of a method for creating a multidimensional surface model from an image. The system receives an image 2902. Sources of images may include, e.g., fingerprints, weld scans, magnetic resonance images, or x-rays. These and any other types of images may be received from scanners, cameras, digitizers, charge-coupled devices, or other devices capable of generating a digital image. Images may also be retrieved from primary or secondary storage coupled to the system. An image may be a two dimensional image as described above. In various embodiments, the image may be comprised of multiple bits of color information, e.g., eight or more bits per pixel. At block 2904, the system processes the image received at block 2902. The technique for processing an image to create a multidimensional surface model is described above. The system may render the generated multidimensional surface model to a user at block 2906. The system finishes at block 2908.

FIG. 30 illustrates a flow diagram for a method for creating classifications and algorithms. At block 2906, the system presents a surface model to a user. At block 3004, the system receives a region of interest that is indicated by a user. The region of interest may be indicated, e.g., by selecting a region of the image using an input device such as a mouse or stylus. The system may enlarge the region of interest specified by the user. At block 3006, the system receives an indication of classifications. As an example, the system may receive indications of portions of a fingerprint that uniquely identify an individual. Features that may be classified include, e.g., fingerprint minutiae such as a short ridge some distance from a crossover that has pores on either side. Alternatively, the system may receive indications of portions of a mammogram that indicate specific characteristics of a mammogram that identify the tendency for the individual whose mammogram was taken to contract breast cancer. Alternatively, the system may receive an indication of characteristics in a weld image indicating whether the structure that has been welded will deteriorate. At block 3008, the system may create algorithms for identifying these classifications. The system may automatically generate such algorithms. Alternatively, a user may manually input an algorithm. An algorithm or rule would be one that a human or computer could follow to identify features in accordance with the classifications. As an example, an algorithm may include first locating the center swirl of a fingerprint, next locating a bifurcation in a ridge some distance away, and then locating two pores on either side of a lake some distance from the bifurcation. At block 3010, the system stores the algorithms and identified classifications in a database. The system finishes this method at block 3012.

FIG. 31 illustrates a method for creating a database of image features. The method receives an image 2902. At block 2904, the method processes the image as described above. Processing the image may include generating a multidimensional surface model. Alternatively, rather than generate a multidimensional surface model, the method merely analyzes certain portions of the received image. As an example, once classifications have been created and the system is adding images and features to a database without human intervention, the system may not need to present a multi-dimensional surface model to the user. Instead, the system can conduct its analysis directly on the image as it has information from the image relating to intensities or shades. At block 3106, the method identifies features according to the classifications previously created and stored at block 3010. The system may use algorithms associated with the type of provided image 2902. As examples, the method may use one type of algorithm for mammograms, and another for welds. Once these features have been identified, the method stores these features in a database at block 3108. The database used at block 3108 may be the same as the database used at block 3010 or may be a different database. The system may also store the image and the resulting surface model in this or another database. If a different database is used to store images or surface models, the stored images or surface models would then be associated with the stored features in the database used at block 3108. The system finishes at block 3110.

FIG. 32 illustrates a block diagram for searching a database of image features. The method receives an image 2902. At block 2904, the method may optionally processes the image as described above in reference to FIG. 31. The method identifies features of the image in accordance with previously identified classifications at block 3106. The method retrieves features at block 3206. The identified features are retrieved from a database of computer searchable image features that was used at block 3108 to store features. One skilled in the art would know how to search for and retrieve information from a database. If no features match the features identified, the system may alert the user to this fact. At block 3208, the method presents the features that have been located in the database. The system may present a list of one or more entries from the database and may optionally present a probability associated with each entry that features in the image 2902 match features associated with the entries. The system may also present an image and surface model associated with the entries located from the database. The method finishes at block 3210.

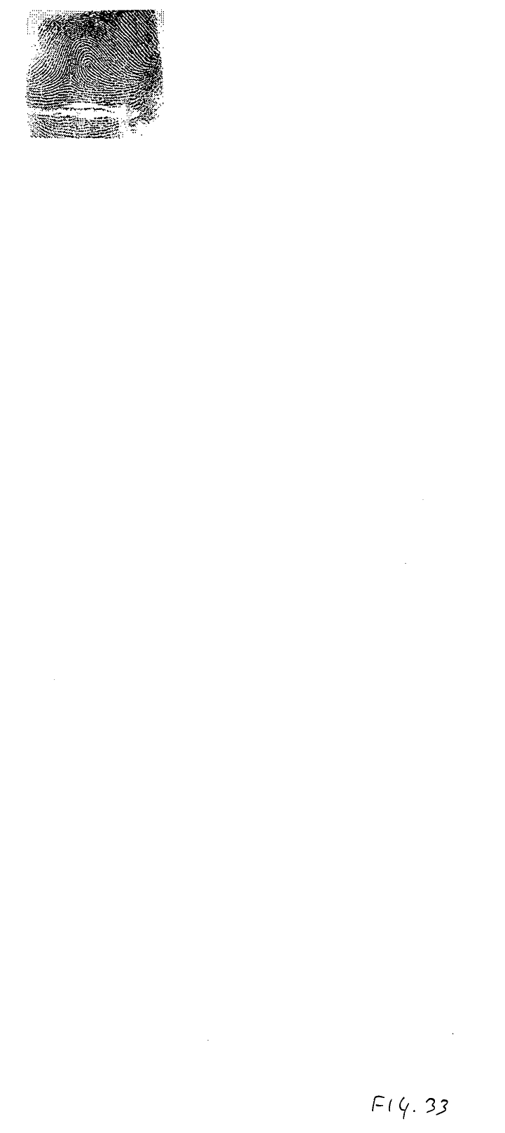

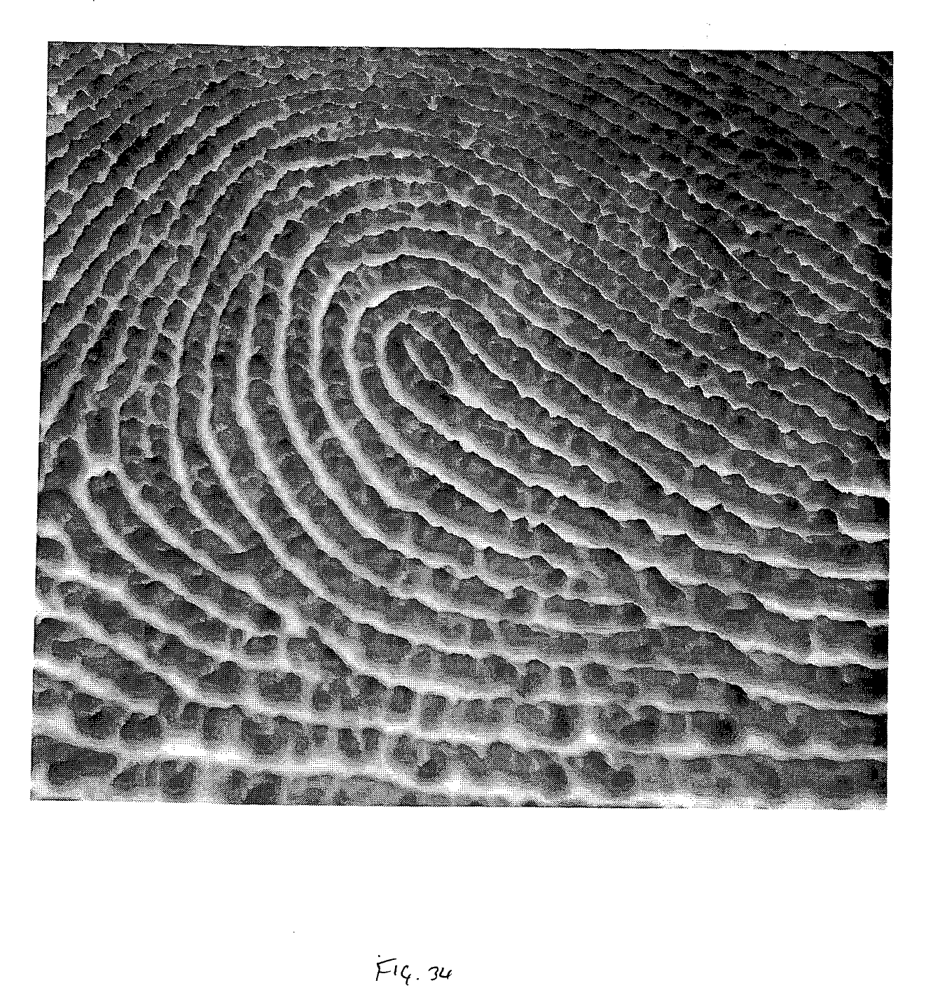

FIG. 33 is an illustration of a fingerprint image provided to the system. The example illustrates a fingerprint image that was scanned from an ink image. A conventional scanner was used to create this image. One skilled in the art would recognize that there other techniques may be used to create a digitized fingerprint image.

FIG. 34 illustrates a surface model that was created by the system after processing the fingerprint illustrated in FIG. 33. This surface model depicts the characteristics of the fingerprint illustrated in FIG. 33 in what appears to be three dimensions. An analyst who is classifying features of fingerprints may select a specific region of the fingerprint that may define a region of interest. As an example, the identifying marks of a fingerprint are sometimes found near the center swirl of a fingerprint.

FIG. 35 illustrates a region of interest from FIG. 34. The system has enlarged the region of interest. An analyst or the system has then highlighted the identifying features of this fingerprint by encircling them. The minutiae that are encircled in the surface model include ridge endings, bifurcations, “lakes,” and short ridges. One skilled in the art of fingerprint analysis would recognize that these minutiae may uniquely identify an individual whose print is provided.

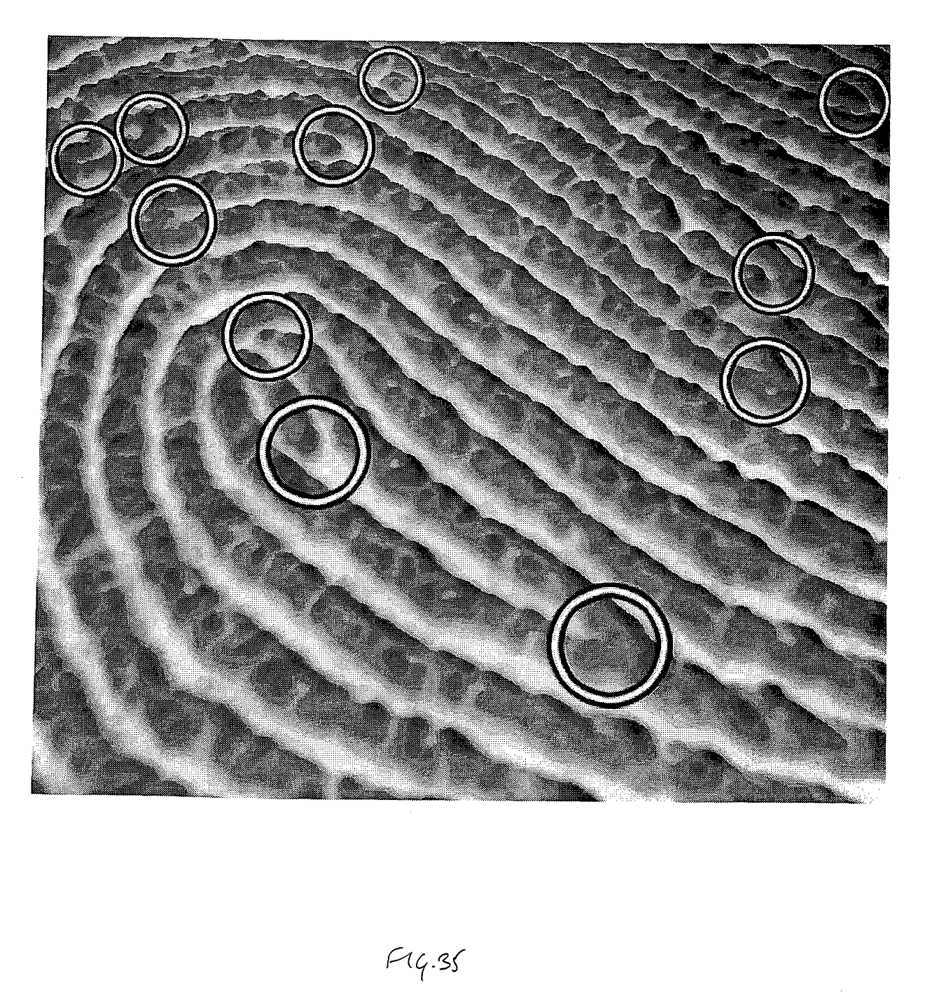

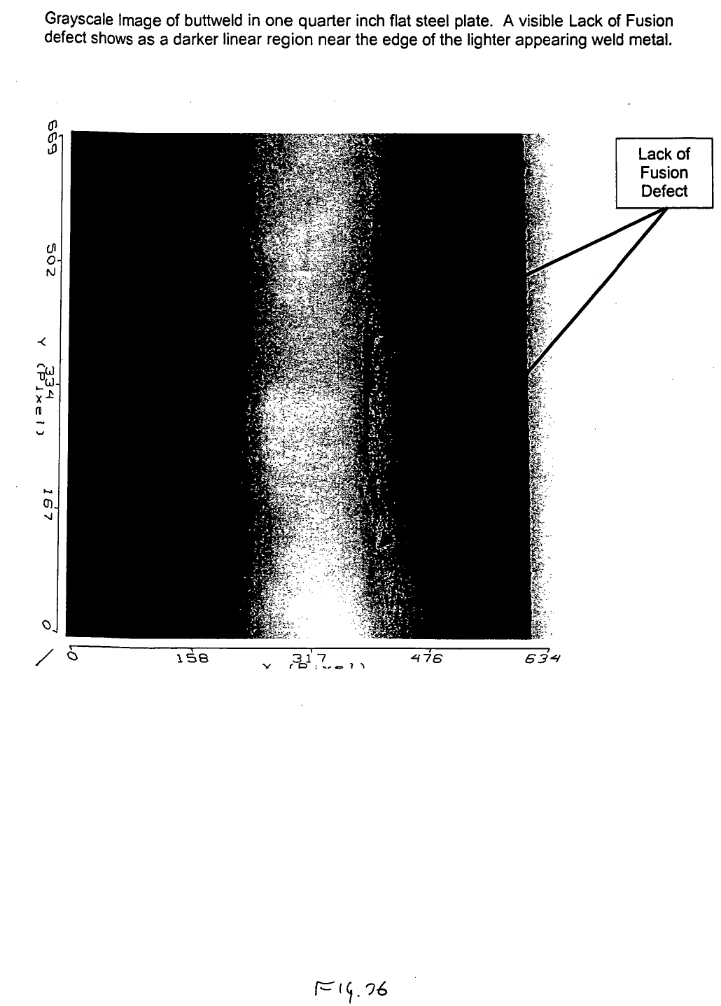

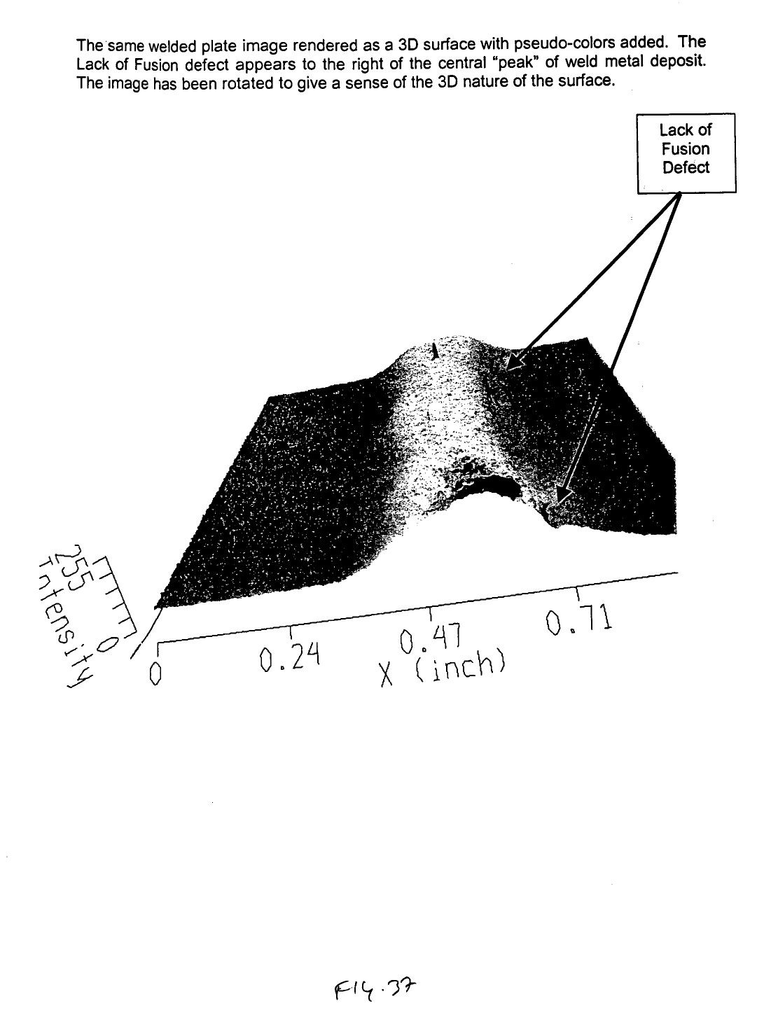

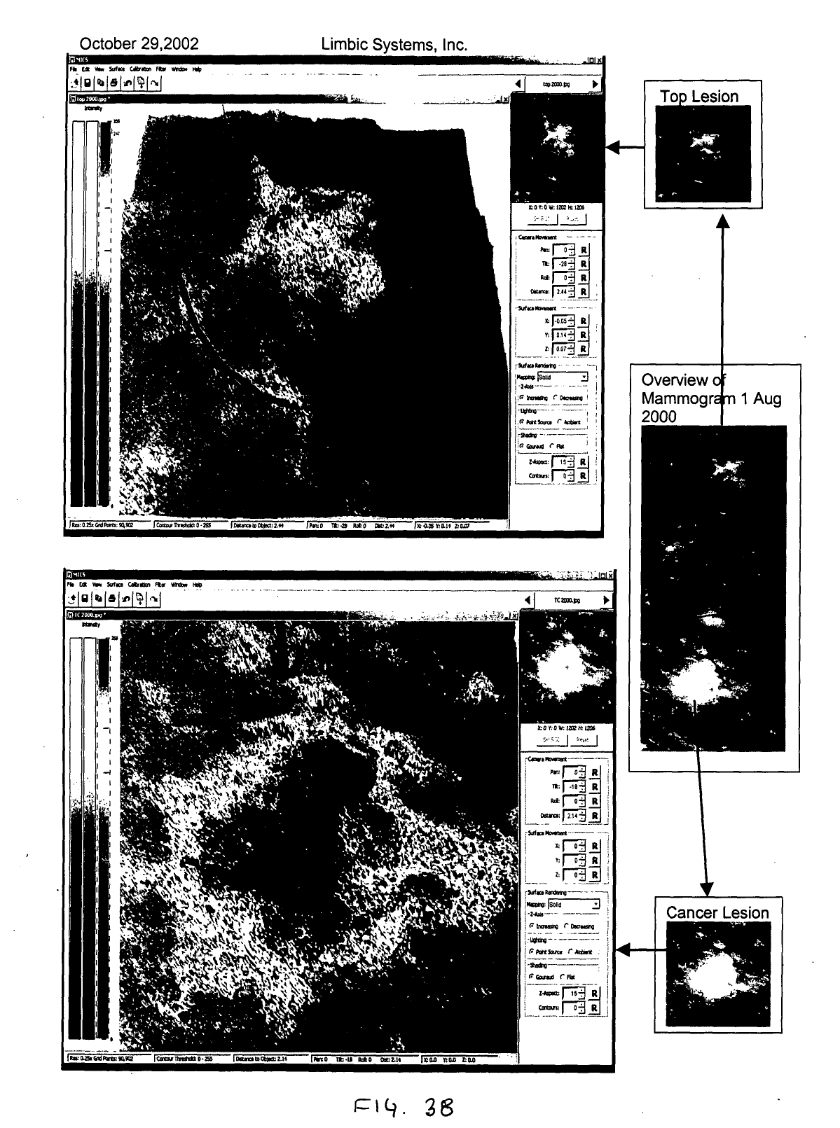

FIG. 36 illustrates an image of a weld. This image may have been created using a digital camera. The Figure further shows a line running in the direction of the weld. This line appears to have a shade that is darker than the weld itself. However, it is unclear from the image what the shade represents.

FIG. 37 illustrates a surface model created from the image of FIG. 36 by the system. The surface model appears to show a concave region to the right side of the “peak” of the weld metal deposit. This concave region may identify that the weld has not properly fused. Further, the system may be provided with images created from the weld over time. The system would then be able to identify whether the defect in the weld fusion is deteriorating.

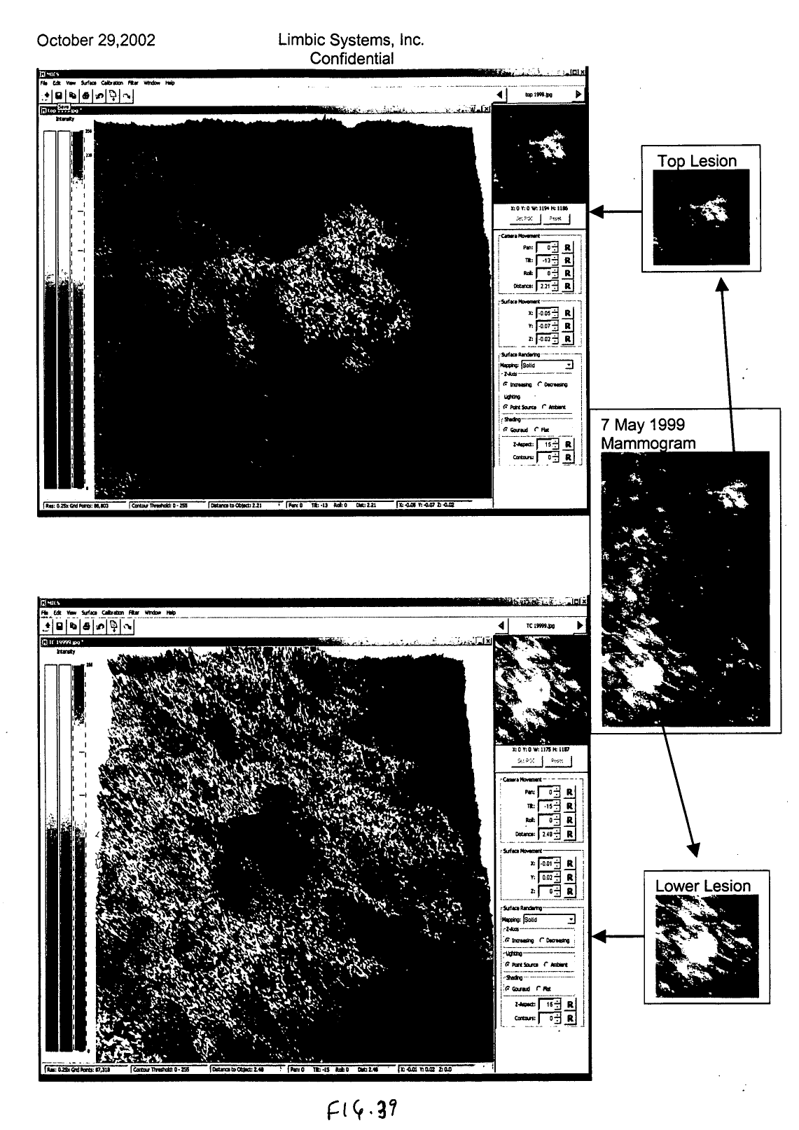

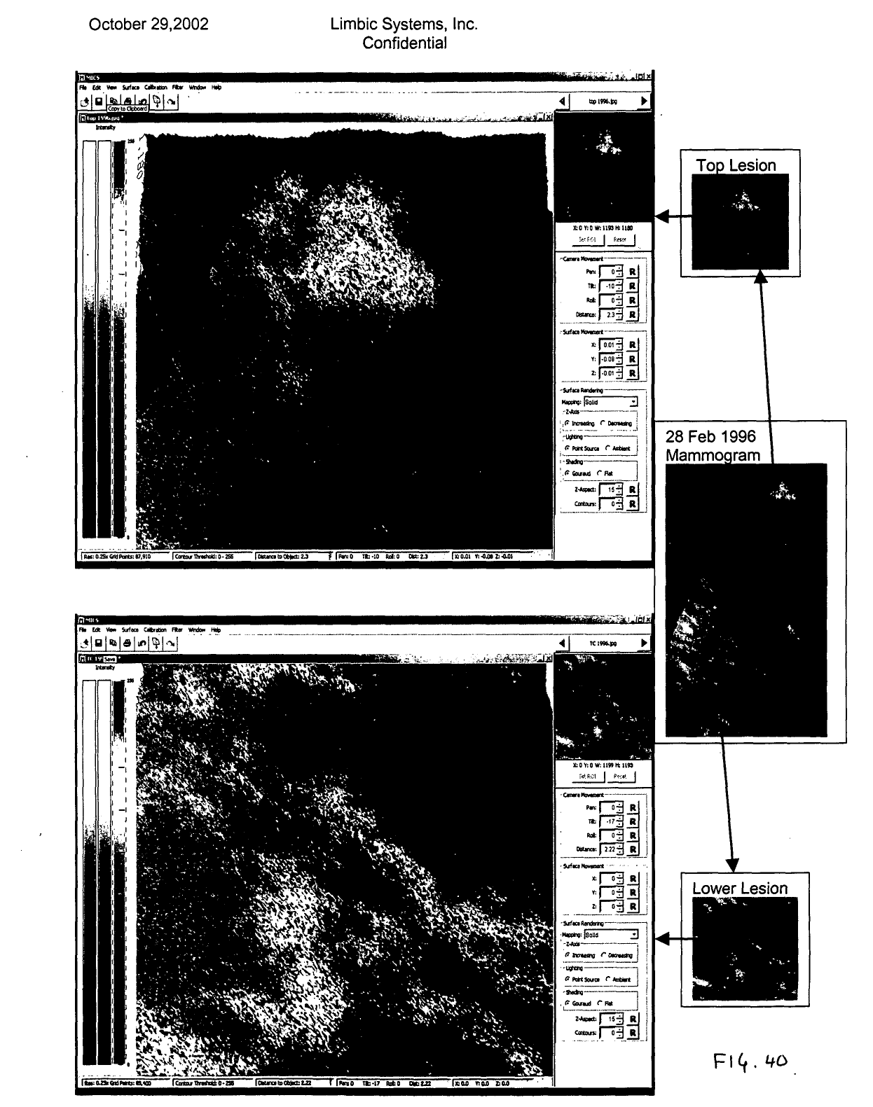

FIG. 38 illustrates a mammogram taken on Aug. 1, 2000. It shows two cancer lesions. The two large images correspond to surface models created from the smaller images using the system described above. FIGS. 39 and 40 show the same areas on May 7, 1999 and Feb. 28, 1996, respectively. As the images show, the lesions have developed over time. However, the lesions are not as clearly visible in the smaller images. An oncologist may appreciate the diagnostic capabilities presented by the enhanced surface models, and may be able to identify features in the surface models that may be used to classify, store, and retrieve other mammograms in an effort to diagnose such lesions more easily.

The invention is described above with respect to various embodiments. The description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The terminology used in the description is intended to be interpreted in its broadest reasonable manner, even though it is being used in conjunction with a detailed description of certain specific embodiments of the invention. Certain terms may even be emphasized; however, any terminology intended to be interpreted in any restricted manner is overtly and specifically defined as such.

I/we claim:

1. A method for creating a searchable library of classifications of image features, the method comprising:
receiving a digital image of a physical object;
automatically generating a multi-dimensional surface model from the received digital image of the physical object, and which differs from the received digital image;
providing an output that displays the generated multi-dimensional surface model;
manually analyzing the generated multi-dimensional surface model to determine selected features of the received digital image;
classifying the determined features;
storing the feature classifications;
creating an algorithm for locating classified features in surface models of physical objects based on the stored classifications; and
storing the algorithm.

2. The method of claim 1 wherein the received digital image has eight bits of image intensity information.

3. The method of claim 1 wherein the received image has more than eight bits of image intensity information.

4. The method of claim 1 wherein the generated multi-dimensional surface model includes information that is not plainly discernable in the received image.

5. The method of claim 4 wherein intensity transitions in the received image are represented in the generated surface model by changes in color.

6. The method of claim 4 wherein intensity transitions in the received image are represented in the generated surface model by changes in surface heights.

7. The method of claim 1 wherein the analyzing is done automatically.

8. The method of claim 7 wherein the analyzing is done by a learning algorithm.

9. The method of claim 8 wherein the learning algorithm is a neural network.

10. The method of claim 8 wherein the learning algorithm is a genetic algorithm.

11. The method of claim 1 wherein the classifying is done heuristically.

12. The method of claim 1 wherein the classifying is done manually.

13. The method of claim 1 wherein the feature classifications include temporal classifications.

14. The method of claim 1 wherein the created classifications are based on a probability that features identified in accordance with the classifications distinguish the physical objects the digital images represent.

15. The method of claim 1 wherein the algorithm includes rules for identifying features.

16. The method of claim 1 wherein the created classifications are associated with the received digital images.

17. The method of claim 1 wherein the created classifications include features relating to fingerprint analysis.

18. The method of claim 17 wherein the physical object is a fingerprint.

19. The method of claim 1 wherein the created classifications include features relating to odontology.

20. The method of claim 19 wherein the physical object is a tooth.

21. The method of claim 1 wherein the created classifications include features relating to oncology.

22. The method of claim 21 wherein the physical object is a human cell.

23. The method of claim 1 wherein the created classifications include features relating to weld analysis.

24. The method of claim 23 wherein the physical object is a weld.

25. The method of claim 1 wherein the created classifications include features relating to baggage screening.

26. The method of claim 25 wherein the physical object is an article of baggage.

27. The method of claim 1 wherein the created classifications include features relating to geo-spatial mapping.

28. The method of claim 27 wherein the physical object is an object being mapped.

29. The method of claim 1 wherein the created classifications include features relating to gemology.

30. The method of claim 29 wherein the physical object is a gem.

31. A method for creating a computer-searchable library of image features, the method comprising:
receiving a digital image having an arrangement of pixels, wherein each pixel in the arrangement has a value of more than one bit;
automatically generating a multi-dimensional surface model from the received image that visually enhances transitions in values of adjacent pixels in the digital image;
analyzing the generated surface model to determine features of the received image in accordance with predetermined classifications to identify classified features in the digital image; and
storing the classified features in a database.

32. The method of claim 31 including storing the received image with associated classified features.

33. The method of claim 31 including storing the generated surface model with associated classified features.

34. The method of claim 31 wherein the automatically generating includes creating a pseudo three-dimensional image having varying edges, heights and surfaces based on transitions in values of adjacent pixels in the digital image.

35. The method of claim 31, further comprising:
automatically creating a two-dimensional image representing a set of the classified features and relative distances between each of the classified features in the set, wherein the two-dimensional image contains fewer image features than either the digital image or the surface model; and
storing the created two-dimensional image in the database.

36. The method of claim 31, further comprising:
automatically creating a set of the classified features and distances between each of the classified features in the set, wherein the set contains less data than either the digital image or the surface model; and
storing the created set in the database.

37. The method of claim 31 wherein the visual enhancement includes varying edges.

38. The method of claim 31 wherein the visual enhancement includes varying surface heights.

39. The method of claim 31 wherein the visual enhancement includes varying colors.

40. The method of claim 31 wherein the automatically generating includes creating a pseudo three-dimensional image having varying edges, heights, surfaces, and colors based on transitions in values of adjacent pixels in the digital image.

41. A method of analyzing a source image, comprising the steps of:
generating a source image data set comprising display data and location data, wherein
the location data indicates the location of the display data with reference to a two-dimensional coordinate system, and
the display data is used to reproduce the source image;
generating a surface model based on the source image data set, wherein
the surface model is derived from location data corresponding to the location data of the source image data set and intensity data generated based on the display data; and
analyzing the surface model to determine features of the source image.
